(19) United States
(12) Patent Application Publication
(10) Pub. No.: US 2026/0247237 A1
(43) Pub. Date: Aug. 20, 2026

(54) MANAGING NETWORK CONNECTIVITY IN A WIRELESS COMMUNICATION SYSTEM

(71) Applicant: CANON KABUSHIKI KAISHA, Tokyo (JP)

(72) Inventors: Pascal LAGRANGE, La Chapelle des Fougeretz (FR); Pierre VISA, RENNES (FR)

(21) Appl. No.: 18/993,205

(22) PCT Filed: Jul. 10, 2023
(86) PCT No.: PCT/EP2023/069004

§ 371 Date: Jan. 10, 2025

(30) Foreign Application Priority Data
Jul. 13, 2022 (GB) 2210295.8
Sep. 29, 2022 (GB) 2214295.4

(51) Int. Cl. H04W 36/08

(52) U.S. Cl. CPC H04W 36/08

(57) ABSTRACT

A method for use in managing network connectivity in a wireless communication system including at least one mobile Integrated Access and Backhaul, (mIAB), node is disclosed. The method at a mIAB node comprises providing, to a wireless communication device, a mobility message, wherein the mobility message includes at least one of: mobility profile information indicating the mobility capability of the mIAB node; guaranteed static time information indicating a minimum time period for which the mIAB node remains at a certain location. The mobility profile information may include at least one of: speed information indicating a speed capability of the mIAB node, range information indicating a mobility area of the mIAB node, static information indicating a duration of one or more static periods the mIAB node may experience, itinerary information indicating a sequence of mobility and static periods for an itinerary the mIAB node may follow.

### FIELD OF THE INVENTION

The present invention generally relates to managing network connectivity in a wireless communication system. Particularly, the present invention relates to managing network connectivity in a wireless communication system including at least one mobile Integrated Access and Backhaul, IAB, node.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP®) standards, such as fourth-generation (4G) Long Term Evolution (LTE) or recent fifth-generation (5G) New Radio (NR) systems, or systems-based IEEE 802.11 standards, such as WiFi.

The demand for network densification increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

Urban environments are usually characterised by a high density of users along with the presence of a significant number of vehicles (e.g. public/private passengers transportation, goods delivery, food trucks . . . ). The speed of some of the vehicles may be pretty low or at least similar to pedestrian speed and some of these vehicles may even be temporarily stationary. Some of these vehicles (e.g. buses, trains or trams), may have predictable routes and/or limited mobility areas (e.g. some vehicles, such as food trucks or promotional vehicles, may be located outside stadiums or show venues) while others may have predictable stationary locations (e.g. taxis).

3GPP is considering that such vehicles could offer an opportunity to increase network coverage and connectivity to the UEs inside the vehicles, or even to UEs in proximity to the vehicles, by installing on these vehicles on-board base stations (or base station elements) that would act as relays. These relays would rely on 5G wireless backhaul (typically IAB, or Integrated Access & Backhaul) for connecting to a fixed donor device. Thus, based upon the fixed IAB foundations set out in Releases 16 and 17, 3GPP is now considering Mobile IAB systems and architecture, as a part of the Release 18 framework, in order to address scenarios focusing on mobile IAB-nodes mounted on vehicles (for example, a bus, a train, a taxi). In such scenarios, mobile IAB-nodes can also be referred to as Vehicle Mounted Relays (VMR), providing 5G coverage/capacity to on-board and/or surrounding UEs. The technical benefits of using vehicle relays include, among others, the ability of the relay vehicle to get better coverage than the nearby UE, thanks to better RF/antenna capabilities, thus providing the UE with a better link to the macro network. Additionally, a vehicle relay is expected to have less stringent power/battery constraints than the UEs.

As a VMR or a mobile IAB (mIAB) node may be static at some point (e.g. taxi in a car park or at a taxi rank, bus in a car park or at a bus stop, train at a station, or temporary installation at an event or emergency/disaster case) while moving otherwise, the connection with mobile IAB (mIAB) nodes, or Vehicle Mounted Relays (VMR), is likely to fluctuate based on their actual movement. Therefore, in order to take benefit of the extra connectivity resulting from the presence of a mobile IAB node in the topology while mitigating the connectivity impact that may result from its actual mobility status, the connection of a child IAB node, either fixed or mobile, to the network via or through such mobile IAB node should be managed carefully, requiring some dedicated signaling to the other IAB nodes, including the IAB donor, for connection setup or dynamic mobility status notification purpose.

As a given IAB topology may, at some point, be made up of both legacy IAB devices (belonging to former Releases 16 and 17), which do not have any ability to differentiate mobile IAB-nodes from fixed IAB-nodes, and more recent IAB devices (belonging to release 18 and further) having the ability to handle mobile IAB connectivity, managing the connectivity of different kinds of IAB devices (e.g. legacy and the more recent IAB devices) to the network via or through a mobile IAB device also needs to be taken into account.

Also, considering the aforementioned fluctuation of the connectivity associated to a mobile IAB node, it may also be desirable to carefully manage the connection of both the on-board and/or surrounding User Equipment (UEs) that may be in range of a mobile IAB node.

Therefore, some new mechanisms are required to address at least some of the aforementioned issues, while limiting the complexity of the processing at an IAB-node as well as the latency that would result from such processing.

### SUMMARY

In accordance with a first aspect of the present invention, there is provided a method for use in managing network connectivity in a wireless communication system including at least one mobile Integrated Access and Backhaul, (mIAB), node, the method at a mIAB node comprising: providing, to a wireless communication device, a mobility message, wherein the mobility message includes at least one of: mobility profile information indicating the mobility capability of the mIAB node; guaranteed static time information indicating a minimum time period for which the mIAB node remains at a certain location.

In an example, the the mobility profile information includes at least one of: speed information indicating a speed capability of the mIAB node, range information indicating a mobility area of the mIAB node, static information indicating a duration of one or more static periods the mIAB node may experience, itinerary information (which may alternatively be referred to as trajectory information) indicating a sequence or succession of mobility and static periods for an itinerary the mIAB node may follow.

By providing the mobility profile information and/or the guaranteed static time information (e.g. on setup and/or after one or more connections to the mobile IAB node have been established), a receiving wireless communication device (such as an IAB donor CU, UE or another IAB node) can receive information about the mobile capability and/or current static status of the mobile IAB node and with the additional information about the mobility of the mobile IAB node act accordingly. In other words, the mIAB node can advertise its mobility capability and/or static status to one or more UEs and one or more other IAB nodes in the vicinity of the mIAB node. With additional information regarding the mobility capability of the mIAB node and/or the guaranteed static time information, the UEs and/or other IAB nodes and/or IAB donor node have additional information and so can act more effectively. For example, a UE and/or another IAB node may decide not to connect to the network via the mIAB node due to its mobility or may decide to connect despite the mIAB node's mobility (e.g. because the information indicates the mIAB node is travelling slowly or within a limited area). In another example, where a UE and/or another IAB node is already connected, the UE and/or another IAB node may decide to initiate a cell search procedure to look for another IAB node to connect to or handover to.

In accordance with a second aspect of the present invention, there is provided a method at a wireless communication device of a wireless communication system as recited in claim 19 of the accompanying claims.

In accordance with a third aspect of the present invention, there is provided a method at an Integrated Access and Backhaul, IAB, donor node of a wireless communication system as recited in claim 32 of the accompanying claims.

In accordance with a fourth aspect of the present invention, there is provided a method, at an Integrated Access and Backhaul, IAB, node, for use in managing network connectivity in a wireless communication system as recited in claim 49 of the accompanying claims.

In accordance with a fifth aspect of the present invention, there is provided a method at a wireless communication device of a wireless communication system as recited in claim 59 of the accompanying claims.

In accordance with a sixth aspect of the present invention, there is provided apparatus for an Integrated Access and Backhaul, IAB, node of a wireless communication system as recited in claim 62 of the accompanying claims.

In accordance with a seventh aspect of the present invention, there is provided apparatus for an Integrated Access and Backhaul, IAB, donor node of a wireless communication system as recited in claim 63 of the accompanying claims.

In accordance with an eighth aspect of the present invention, there is provided apparatus for a wireless communication device as recited in claim 64 of the accompanying claims.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a block schematic diagram illustrating an example wireless communication system (or IAB network) in which the present invention may be implemented according to one or more embodiments;

FIG. 5 is a schematic and simplified diagram illustrating example message flows for use in managing network connectivity in a wireless communication system including at least one IAB node in accordance with one or more embodiments of the invention and which may be used for managing the advertising by an IAB node of its mobility capability and status along with its ability to support IAB connection with a child IAB node;

FIG. 6 is a flowchart of an example method for managing mobile IAB-node connectivity according to one or more embodiments of the present invention;

FIG. 7 is a schematic and simplified diagram illustrating example message flows for use in managing the connection of a wireless communication device (or network device) to a network of a wireless communication system via a mobile IAB node according to one or more embodiments of the present invention;

FIG. 8 is a flowchart of an example method for use in managing the connection of a wireless communication device (or network device) to a network of a wireless communication system via a mobile IAB node according to one or more embodiments of the present invention;

FIG. 9 is a flowchart of an example method for a wireless communication device (or network device) to manage its connection to the network of a wireless communication system via a mobile IAB node according to one or more embodiments of the present invention;

FIG. 10 shows a block schematic representation of a wireless communication device in accordance with embodiments of the present invention;

FIG. 11 is a flowchart of an example method for use in managing network connectivity, in a wireless communication system including at least one mobile IAB node, in accordance with one or more embodiments of the present invention;

FIG. 12 is a flowchart of an example method performed at a wireless communication device in accordance with one or more embodiments of the present invention;

FIG. 13 is a flowchart of an example method performed at an IAB donor node of a wireless communication system in accordance with one or more embodiments of the present invention; and

FIG. 14 is a flowchart of an example method for use in managing network connectivity, in a wireless communication system including at least one mobile IAB node, in accordance with one or more embodiments of the present invention.

### DETAILED DESCRIPTION

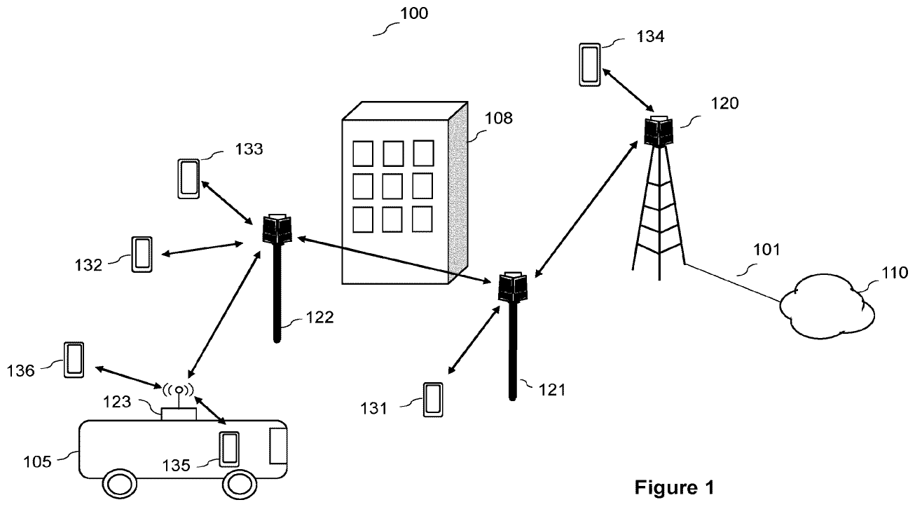

FIG. 1 illustrates an example communication system 100 in which the present invention may be implemented according to one or more embodiments.

As depicted, the example system 100 is a wireless communication system, in particular a mobile radio communication system such as a fifth-generation (5G) New Radio (NR) system including a wireless Integrated Access and Backhaul (IAB) communication system or network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul communication system which shares radio resources for wireless access links and wireless backhaul links.

The system 100 comprises a plurality of UEs (User Equipment) 132, 133, 131 and 134, a remote core network 110, a main Base Station 120, two fixed Integrated Access and Backhaul (IAB) stations 121 and 122 or IAB nodes 121 and 122 (also referred to in the following as IAB-nodes) and a mobile Integrated Access and Backhaul (IAB) station or mobile IAB node 123 mounted on a vehicle 105 (for example, a bus, a train, a taxi, a car, etc.).

The main Base Station 120, also referred to as the IAB-donor 120 (or IAB donor), is connected to the core network 110 through a wired link 101, preferably an optical fiber or any other wired means. In embodiments and examples of embodiments of the invention, IAB-donor 120 is a 5G NR base station (referred to as a gNB) with additional functionality to support IAB features, as defined in 3GPP TS 38.300 v 17.0.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The Mobile IAB station 123, also referred to as IAB-node 123 or mIAB node 123, which is mounted on vehicle 105, also provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121, 122 and 123 are thus forming a backhaul network or IAB network (also referred to as IAB topology), which accommodates UEs 131, 132, 133, 134, 135 and 136. The terms IAB network and IAB topology will be used interchangeably in the following. The IAB network forms the Radio Access Network (RAN) or as referred to with respect to 5G, Next Generation (NG) RAN.

The specification of the Integrated Access and Backhaul (IAB) is spread over several 3GPP standard documents, including:
TS 38.300 RAN architecture (V17.0.0),
TS 38.321 MAC protocol (V17.0.0),
TS 38.331 Radio Resource Control (RRC) protocol (V17.0.0),
TS 38.340 Backhaul Adaptation Protocol Layer (V17.0.0),
TS 38.401 RAN architecture (V17.0.0),
TS 38.473 F1 Application Protocol (V17.0.0).

As IAB-nodes 121, 122 and 123 are respectively connected to UEs 131, 132, 133, 134, 135 and 136, they are considered as Access IAB-nodes for their respectively connected UEs.

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU or IAB donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU or IAB donor DU) includes lower layer protocols, such as the RLC, MAC and physical layer protocols. The IAB-donor CU and IAB-donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality.

The IAB nodes, which may serve multiple radio sectors, are wireless backhauled to the IAB-donor 120, via one or multiple hops (e.g. via one or more IAB-nodes). They form a directed acyclic graph (DAG) topology with the IAB-donor at its root.

Each IAB node consists of an IAB-DU (IAB-Distributed Unit) and an IAB-MT (IAB-Mobile Termination). The gNB-DU functionality on an IAB-node is also referred to as IAB-DU and allows the downstream (toward the UE) connection to the next-hop IAB or to a UE. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node.

The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

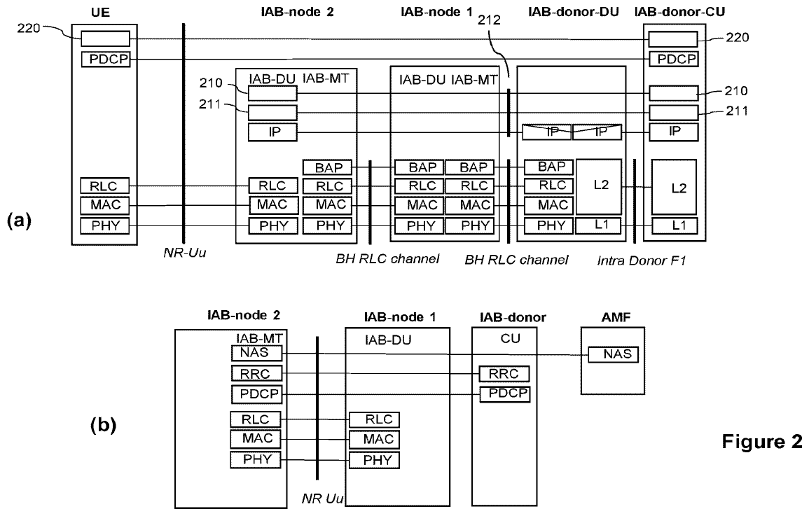

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU. F1-U is the functional interface in the User Plane (UP) for the same units. F1-C and F1-U are shown by reference 212 in FIG. 2a. In this example, F 1-U and F1-C are carried over two backhaul hops (from IAB-donor to IAB-node1 and then from IAB-node1 to IAB-node2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS 38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or PDUs or data units. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

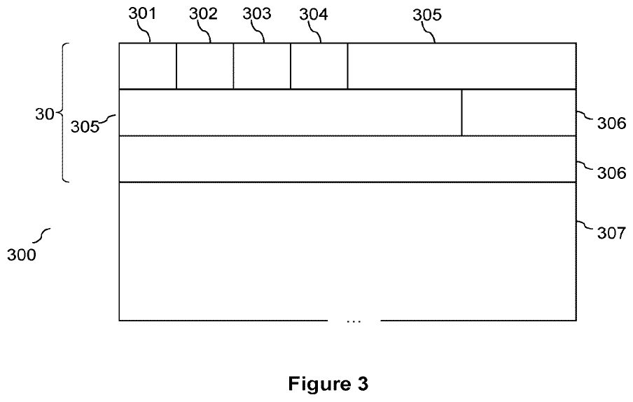

On the BAP sublayer, packets are routed based on the BAP routing ID, which is carried in the BAP header and which is set by the BAP sublayer of the network node in the IAB network generating the BAP packets. FIG. 3 illustrates the format of a BAP Data Protocol Data Unit (PDU) or packet. It is specified in the standardized version paragraph 6.2 of 3GPP TS 38.340 release 17.0.0.

The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU is configured (by an IAB-donor CU which controls the IAB network or topology to which the IAB-node and IAB-donor DU belong) with a designated BAP address. Field 306 carries a path ID identifying the routing path the BAP packet should follow to this destination in the IAB topology. The routing paths, including their path IDs, are configured in the same way the BAP address is configured.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by an IAB-node, i.e. either by the IAB-donor for downstream transmission or by an initiator IAB-node for upstream transmission (which may be an access IAB-node should the upper layer packets come from a UE), the BAP header with the BAP Routing ID is built by this IAB-node according to a configuration table defined in 3GPP TS 38.340. This table is called Downlink Traffic to Routing ID Mapping Configuration table in the IAB-donor or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU controlling the IAB network and transmitted to the IAB-nodes to configure them.

To process the transport of messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter side or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at the emitter side. At the receiver side the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS 38.323.

SDAP sublayer 220 for the User Plane handles the Quality of Service. It is described in TS38.324. On the UE side, the SDAP sublayer exchanges the payload data with the user's application (voice, video, etc . . . —not shown in the Figure). On the IAB-donor side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v17.0.0 and illustrates the protocol stack for the support of IAB-MT's RRC and NAS connections. The Non-Access Stratum (NAS) protocol handles the messages between the core network and a user equipment, here an IAB-node. It manages the establishment of communication sessions and maintains communications with the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

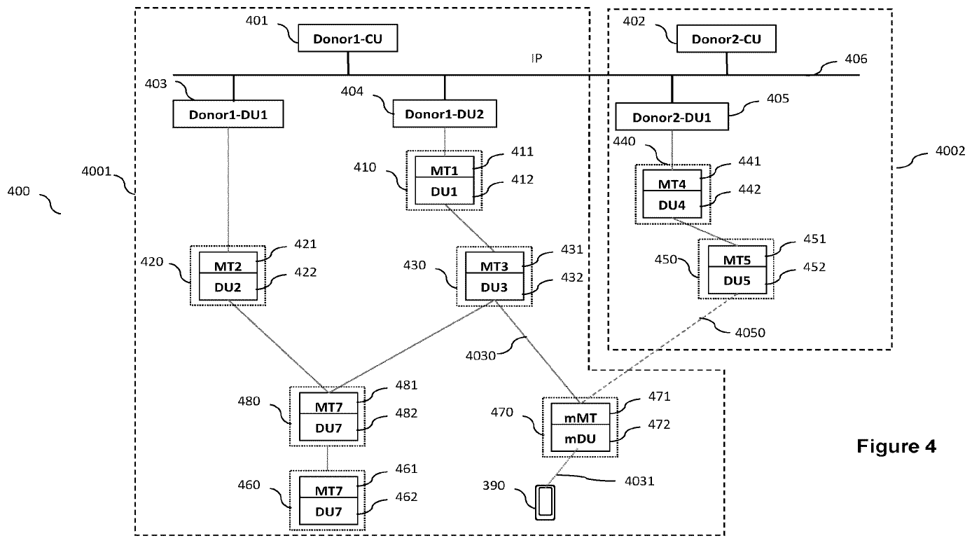

FIG. 4 illustrates an example of a wireless communication system 400, including an IAB network or IAB network system, in which embodiments and examples of embodiments of the present invention may be implemented. In one example implementation, the radio links between the IAB nodes and IAB donor DU nodes (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

The IAB network system of FIG. 4, which forms part of the NG RAN, is composed of two IAB networks or IAB topologies 4001 and 4002 with each IAB topology comprising a set of IAB nodes (e.g. the set may comprise a plurality of IAB nodes or at least one IAB node) and a IAB-donor CU for controlling or managing the plurality of IAB nodes. The set of IAB nodes may include one or more IAB-nodes, such as initiator IAB-nodes which generate BAP packets and also intermediate or relay IAB-nodes. The set of IAB nodes may also include one or more IAB donor DUs. Each of the IAB nodes communicate with at least one other IAB node over a wireless backhaul (BH) link.

Although FIG. 4 shows two IAB topologies 4001 and 4002, the present invention is not limited to two IAB topologies 4001 and 4002 and may be implemented in an IAB communication system comprising more than two IAB topologies with each topology comprising a set of IAB nodes and an IAB donor CU as discussed above.

IAB topology 4001 includes IAB-donor-CU 401 (identified as Donor1-CU in FIG. 4), its associated IAB-donor-DUs, IAB-donor-DU 403 (identified as Donor1-DU1 in FIG. 4) and IAB-donor-DU 404 (identified as Donor1-DU2 in FIG. 4), and a plurality of IAB nodes 410, 420, 430, 460, 480, similar to IAB-nodes 121 and 122, and IAB-node 470, similar to mobile IAB-node 123.

IAB topology 4002 includes IAB-donor-CU 402 (identified as Donor2-CU in FIG. 4), and its associated IAB-donor-DU 405 (identified as Donor2-DU1 in FIG. 4), and a plurality of IAB-nodes 440 and 450, similar to IAB-nodes 121 and 122. The IAB network 400 can provide network path diversity through several IAB-donor-DUs and different IAB networks or topologies.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 410 comprises a MT part or unit 411 and a DU part 412.

A wired backhaul IP network interconnects the IAB-donor-CUs 401 and 402, and the IAB-donor-DUs 403, 404 and 405 through wired link 406. For instance, this wired link consists of optical fiber cable(s).

IAB-Donor-CU 401, IAB-Donor-DUs 403 and 404, IAB-nodes 410, 420, 430, 460, 470 and IAB-node 480 are part of the same IAB network or IAB topology 4001, which is controlled (e. g configured and/or managed) by IAB-Donor-CU 401.

IAB-Donor-CU 402, IAB-Donor-DU 405 and IAB-nodes 440 and 450 are part of the same IAB network or IAB topology 4002, which is controlled (e.g. configured and/or managed) by IAB-Donor-CU 402.

IAB-node 470 is connected to the parent IAB-node 430 through BH link 4030. IAB-node 470 is also connected to a UE 390 through communication link or radio link 4031: the IAB-node 470 is acting as an access node for UE 390. Although FIG. 4 shows only one UE 390, it will be appreciated that there will be a plurality of UEs connected to IAB nodes of the wireless communication system. Although IAB-node 470 belongs to IAB network 4001 (with IAB-node 430 as a parent through the BH link 4030), in view of its proximity to IAB network 4002 and in particular to IAB-node 450, IAB-node 470 may connect to IAB-node 450 (which would act as a parent node to IAB-node 470) through wireless BH link 4050. Such connection to IAB-node 450 in addition or in place of the connection to IAB-node 430 is possible for a stationary IAB-node, and it is very likely to happen for a mobile IAB-node, like IAB-node 470, moving, for instance, in the direction of the IAB topology 4002.

Each IAB-node supports wireless communication in a coverage area referred to as a cell. In other words, each IAB-node is associated with a cell. Wireless communication devices (such as UEs, or other IAB-nodes) located within the cell may connect to the IAB-node serving the cell in order to communicate with other devices (e.g. other UEs, IAB-nodes, servers providing access to the Internet, etc.) via the IAB-node. Typically, an IAB-node measures signals from IAB-node of adjacent cells as part of a cell search procedure (e.g. when initially connecting to the network as defined in 3GPP TS 38.300) or as part of a subsequent procedure. The measurements are reported to the IAB donor CU of the IAB-node. For example, with reference to FIG. 4, the IAB-node 470 may report to its IAB donor CU 401 the presence of a new cell served by IAB-node 450 through a measurement report. Based on the analysis of the measurement report (e.g. measurements in the report indicate the signal strength provided by the IAB-node 450 is above a threshold for supporting communications), the IAB donor CU 401 may request to the IAB donor CU 402, to which the IAB-node 450 belongs, the establishment of a dual connectivity for the IAB-node 470 with an additional connection through the IAB-node 450. The IAB donor CU 402 may accept the request and proceed to establish the connection of the IAB-node 470 to the IAB-node 450 according to the procedure described in TS 37.340 v 17.0.0 section 10.2. As a result, the IAB-node 470, still belonging to IAB topology 4001, is now also connected to IAB-node 450, which belongs to IAB topology 4002, and so it may be referred to as a boundary node between IAB topology 4001 and IAB topology 4002. Actually, the IAB-node 470 retains its F1 connection and its RRC connection to the IAB donor CU 401, which can be referred to as the F1-terminating IAB-donor-CU, and it has a second RRC connection with the IAB donor CU 402, which can be referred to as the non-F1-terminating IAB-donor-CU.

As IAB-node or boundary node 470 is part of the IAB topology 4001 (from the F1 connection point of view), it is controlled (e.g. configured and/or managed) by the IAB-Donor-CU 401 of IAB topology 4001. Through the second RRC connection, the IAB donor CU 402, assigns a second BAP address to be used for routing packets through the IAB topology 4002. Thus, IAB-node 470 acting as a boundary node is assigned two BAP addresses: one BAP address for IAB network 4001 and one BAP address for IAB network 4002. Such a boundary node can help provide network path diversity by providing alternative routing paths through the IAB topologies 4001 and 4002.

As the IAB-node 470 is a mobile IAB-node (for example, it is mounted on a vehicle) the IAB-node 470 will not always be stationary and will move so that the connections to the IAB-nodes 430 and 450 may change over time. For example, if the movement of the IAB-node 470 is small such that the IAB-node 470 and IAB-nodes 430 and 450 are still close enough to each other to meet minimum requirements to support communication (e.g. signal strength is above a threshold), the connections with the IAB-nodes 430 and 450 may not change. However, if the movement of the IAB-node 470 is such that the IAB-node 470 moves out of the cell associated with IAB-node 430 and/or out of the cell associated with IAB-node 450, the IAB-node 470 may lose connection with IAB-node 430 and/or IAB-node 450, respectively. In such a case, the connections to the IAB-node as the IAB-node's moves should be managed in order to avoid loss of service for wireless devices connected to the IAB-node 470 (e. g IAB-node 430 and UE 390 as shown in FIG. 4). For example, in order to ensure continuity of service, a handover procedure may be initiated so that the one or more connections of the IAB-node 470 within the IAB communication system (e.g. to IAB-node 430 are handed over to a different cell. As discussed in the introduction, using mobile IAB nodes helps to increase connectivity (e.g. capacity) in the wireless communication system but connection(s) to the mobile IAB node will need to be managed to account for the movement of the mobile IAB node.

The processes for managing one or more network connections in a wireless communication system including one or more mobile IAB nodes will now be described according to some embodiments of the present invention.

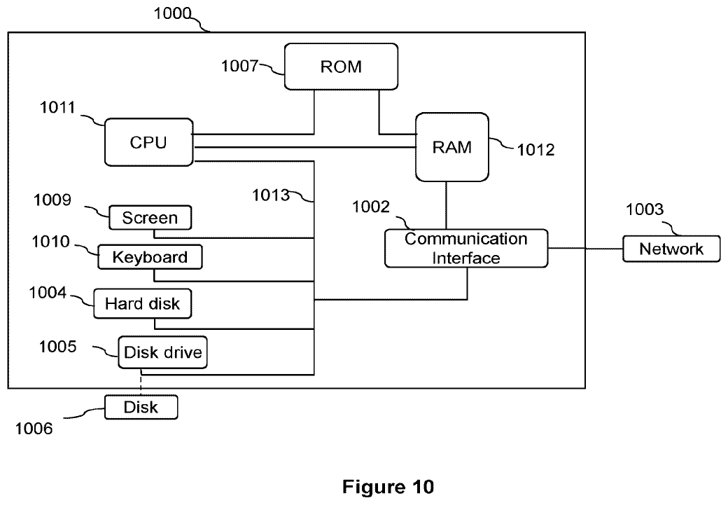

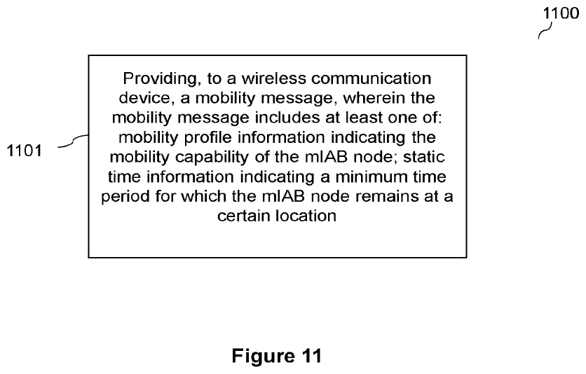

FIG. 11 shows steps of an example method 1100 for use in managing network connectivity, in a wireless communication system including at least one mobile Integrated Access and Backhaul, (mIAB), node, in accordance with an embodiment of the present invention. The method 1100 may be used to manage a connection to a network (e.g. a connection to IAB network system or NG RAN of FIG. 4 which provides connectivity towards the core network) via or through a mIAB node. The method 1100 of FIG. 11 is performed at the mIAB node. For example, with reference to the wireless communication system shown in and described with respect to FIG. 4, the mIAB node performing the method 1100 may be the IAB-node 470 of IAB topology 4001 controlled by the IAB donor CU 401. The method 1100 as shown in and described with respect to FIG. 11 may be performed by software elements and/or hardware elements. The mIAB node may be implemented in a communication device 1000 as shown in and described with reference to FIG. 10 with the method as shown in and described with respect to FIG. 11 being performed by one or more processing units, such as the central processing unit 1011.

Briefly, in step 1101, the mIAB node (e.g. IAB-node 470), provides to a wireless communication device, a mobility message, wherein the mobility message includes at least one of: mobility profile information indicating the mobility capability of the mIAB node; guaranteed static time information indicating a minimum time period for which the mIAB node remains at a certain location. The wireless communication device may be a IAB donor node (e.g. the IAB donor CU) or a UE or another IAB node. More generally, the mIAB node may be a network node of a communications network that can move and the wireless communication device may be a control node for managing the control and data planes of the wireless communications system (e.g. that controls the network node) or a UE or another network node. The following description also applies to this more general scenario.

In an example, the mobility profile information may include at least one of the following: speed information indicating a speed capability of the mIAB node, range information indicating a mobility area of the mIAB node, static information indicating a duration of one or more static periods the mIAB node may experience, itinerary information indicating a sequence of mobility and static periods for an itinerary the mIAB node may follow. The speed information may include information indicating one or more of a minimum speed capability of the mIAB node, average speed capability of the mIAB node, maximum speed capability of the mIAB node. The range information may include information indicating an area in which the mIAB node may move or range of movement of the mIAB node. For example, the range information may include a type or category of the mobility area in which the mIAB node may move and which can be an indication of the size or nature of the geographical area in which the mobile IAB node may move. For example, the type (or category) of mobility area may indicate the geographical area is a bus route, or a train route, or a car park. The range information additionally or alternatively may include a size of the area (i.e. mobility area) in which the mIAB node may move and/or a list of the cell Identifiers (IDs) of the cells that the mIAB node may visit or has visited previously. The range information additionally or alternatively may include a distance by which the mIAB node may move. The static information may include static time information indicating one or more of minimum static period duration, average static period duration or maximum static period duration. The static information may also include static position information indicating the location where the mIAB will be static. The itinerary information may include information indicating, for each of the mobility and static periods, the duration of the period, the speed of the mIAB node during one or more of the mobility periods, the location of the mIAB node during one or more of the static periods.

The mobility profile information may be configured in the mIAB node at setup or subsequently. For example, the mobility profile information may be saved in memory, such as ROM 1007 or data storage means 1004, of the mIAB node. Setup may occur in the factory or as part of the process of mounting the mIAB node on a vehicle in the case where the mIAB node is a Vehicle Mounted Relay (VMR). The mobility profile information may be configured or updated subsequently based on certain or known changes to mobility of the mIAB node which could depend on certain or known changes to the mobility of the vehicle on which the mIAB node is mounted. The mobility profile information may be configured or updated based on tracking of previous movements of the mIAB node and/or the vehicle on which the mIAB node is or will be mounted.

The guaranteed static time information (or minimum static time information) indicates a minimum time period for which the mIAB node remains at a certain location. For example, this information indicates, for a mIAB node that is currently static, the actual time period the mIAB node will remain static at a certain location. Thus, the guaranteed static time information corresponds to a dynamic parameter. For example, for a mIAB node mounted on a train which is currently stopped in a station, based on the train timetable and/or route information for the train (e.g. which is provided in the mobility profile information), the guaranteed static time information may indicate the minimum time the mIAB node will remain stationary. The guaranteed static time information may be determined by the mIAB node when the mIAB is stationary based on the mobility profile information and may be included in a mobility message. Thus, a mobility message which includes guaranteed static time information may be provided whenever a mIAB node is stationary at a certain location and the mIAB node has determined the actual time period the mIAB node will remain static or stationary at that location.

The mobility message provided by the mIAB node may further include at least one of mobile node indication information indicating whether the mIAB node is a mobile IAB or mobility status indication information indicating a current status of mobility of the mIAB node. The current status of mobility may include whether the mIAB node is moving currently or is stationary, and may also include additional information relating to the nature of the movement such as the current speed, whether the mIAB node is accelerating or decelerating.

In an example, the mIAB node obtains the mobility profile information and/or static time information (e.g. from memory) and generates the mobility message based on the obtained information.

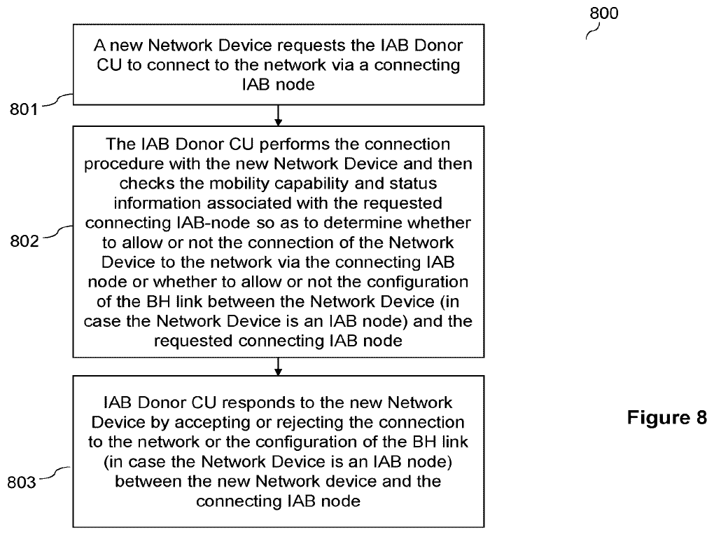

By providing the mobility profile information and/or the guaranteed static time information (e.g. on setup and/or after one or more connections to the mobile IAB node have been established), a receiving wireless communication device (such as an IAB donor CU, UE or another IAB node) can receive information about the mobile capability and/or current mobility status of the mobile IAB node and with the additional information about the mobility of the mobile IAB node act accordingly. For example, an UE or another IAB node may decide not to initiate connection to the network (e.g. the IAB network system of FIG. 4 or NG RAN) via or through the mobile IAB node based on the information provided or an UE or another IAB may decide to initiate a connection via the mobile IAB node but at the same time may also initiate a cell search procedure to look for another IAB node to use to connect to the network. In another example, a IAB donor CU may decide not to accept a connection request for a connection via a mobile IAB node from a new IAB node (or UE) due to the mobility of the mobile IAB node. For example, a IAB Donor CU may prevent a connection of a new UE/IAB-node to the network via the mobile IAB node in the case where the new UE/IAB node is a legacy device (this is discussed in more detail below with reference to FIG. 8). In another example, when the mobility message is provided after a connection has been established and the information in the mobility message indicates a change in mobility of the mobile IAB node (e.g. change in mobility status and/or mobility capability of the mobile IAB (e.g. a change in the guaranteed static time information)), with the additional information about the mobility of the mobile IAB node the wireless communication device can act accordingly. For example, if the change has been significant, a IAB donor CU may decide to release the established connection.

The mobility message may be a mobility indication message (e.g. mobility indication message 521 as discussed in more detail below) provided or sent by the mIAB node to a IAB donor node (such as IAB donor CU 401). The IAB donor node receiving the mobility message from the mIAB node (such as IAB node 470) may be a IAB donor CU that is connected to the mIAB node: for example, a IAB donor CU that is connected to and controlling the mIAB node (such as IAB donor CU 401 which controls IAB node 470) or when the mIAB node acts as a boundary node, the IAB donor CU could be one or more IAB donor CUs to which the mIAB node is connected (such as IAB donor CUs 401 and/or 402 which are connected to the IAB node 470 when the IAB node acts as a boundary node).

Additionally or alternatively, the mobility message may be a mobility information message (e.g. mobility information message 531 as discussed in more detail below) provided or sent by the mIAB node to one or more other IAB nodes (such as IAB nodes 430, 450) or one or more UEs (such as UE 390). For example, the mIAB node (such as IAB node 470) may send a mobility indication message to a IAB donor CU (such as IAB donor CU 401) connected to the mIAB node and may also send a mobility information message to one or more other IAB nodes and/or one or more UEs.

The mobility indication message provided by the mIAB node to the IAB donor node may further include at least one of mobile node indication information indicating whether the mIAB node is a mobile IAB or mobility status indication information indicating a current status of mobility of the mIAB node. The current status of mobility may include whether the mIAB node is moving currently or is stationary, and may also include additional information relating to the nature of the movement such as the current speed, whether the mIAB node is accelerating or decelerating.

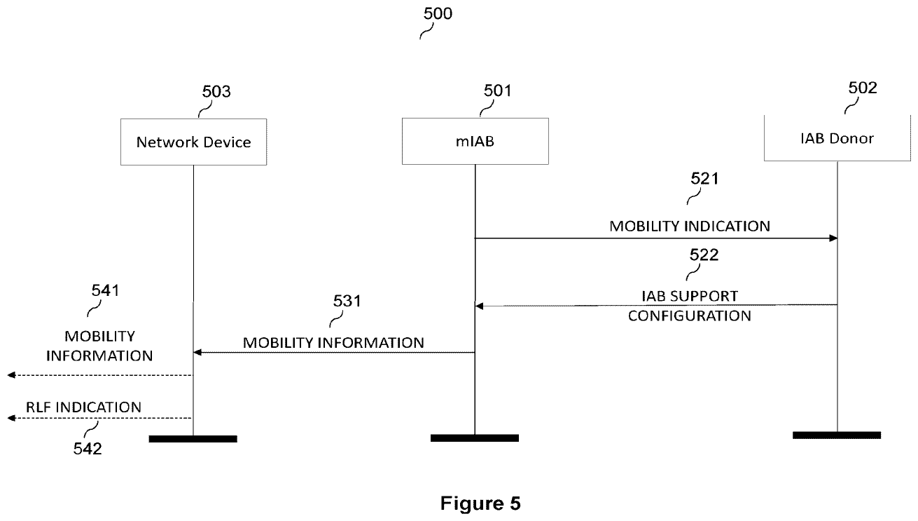

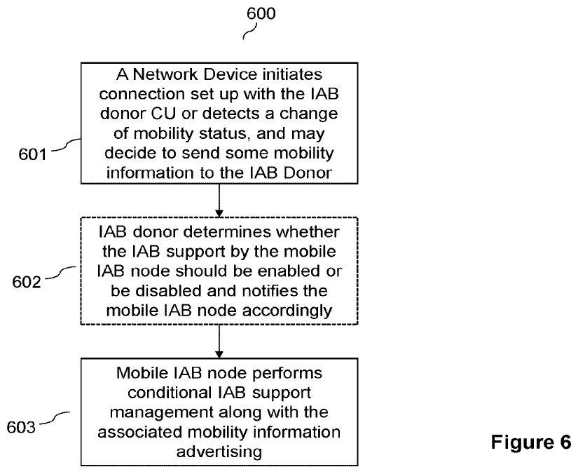

The mobility indication message may be provided by the mIAB node to the IAB donor node (such as IAB donor CU 401 when the mIAB node is IAB node 470 controlled by IAB donor CU 401) in response to one of the following events: 1) after initiating, by the mIAB node, an IAB node setup procedure, such as a connection establishment procedure (for example, a RRC connection establishment procedure as specified in 3GPP TS 38.331 and 3GPP TS 38.401 or a F1 setup procedure, as discussed below in more detail with respect to FIGS. 5 and 6); 2) in response to the mIAB node determining a change in mobility of the mIAB node (e.g. there is a change in mobility status and/or change in mobility capability, such as a change of speed, etc. and/or there is change in the mobility profile information, such as a change in itinerary, etc. and/or there is a change in guaranteed static time information, such as when the mIAB stops at a location and the mIAB determines a new time period for how long the mIAB will remain static at the location); 3) after expiry of a certain time period from the last time a mobility indication message was sent, which time period may be the same or variable between transmissions, such that the mobility indication message is provided periodically; 4) in response to a request from the IAB donor node (such as IAB donor CU 401). For example, the IAB donor node may send a request for up-to-date mobility status information and the mobility indication message including up-to-date mobility status information (e.g. up-to-date mobility profile information and/or guaranteed static time information and may also include mobility status indication information) is provided in response to the request as discussed in more detail below.

The mobility information message provided (e.g. sent) by the mIAB node to one or more UEs (such as UE 390) and/or one or more other IAB nodes (such as IAB nodes 430, 450, 460, 480) may be provided in response to one of the following events: 1) after completion of a IAB node setup procedure (for example, a RRC connection establishment procedure or a F1 setup procedure, as discussed below in more detail with respect to FIGS. 5 and 6); 2) in response to the mIAB node determining a change in mobility of the mIAB node (e.g. there is a change in mobility status and/or mobility capability, such as a change of speed, etc. and/or there is change in the mobility profile information, such as a change in itinerary, etc. and/or there is a change in guaranteed static time information, such as when the mIAB stops at a location and the mIAB determines a new time period for how long the mIAB will remain static at the location); 3) after expiry of a certain time period from the last time a mobility information message was sent, which time period may be the same or variable between transmissions, such that the mobility information message is provided periodically. By providing or sending the mobility information message with the mobility profile information and/or the guaranteed static time information, the mIAB node can advertise its mobility capability and/or status to one or more UEs and one or more other IAB nodes in the vicinity of the mIAB node. On receipt of the mobility information provided in the mobility information message, the UEs and/or other IAB nodes can determine how to act based on the mobility of the mIAB node as indicated by the provided mobility information. With additional information regarding the mobility capability of the mIAB node and/or the guaranteed static time information, the UEs and/or other IAB nodes have additional information and so can act more effectively. For example, a UE and/or another IAB node may decide not to connect to the network via the mIAB node due to its mobility or may decide to connect despite the mIAB node's mobility (e.g. because the information indicates the mIAB node is travelling slowly or within a limited area). In another example, where a UE and/or another IAB node is already connected, the UE and/or another IAB node may decide to initiate a cell search procedure to look for another IAB node to connect to or handover to.

The mIAB node may provide the mobility information message to one or more UEs (such as UE 390) and/or one or more other IAB nodes (such as IAB nodes 430, 450, 460, 480) by broadcast: for example, in a SIB1 message.

The mobility information message provided by the mIAB node to one or more UEs and/or one or more other IAB nodes may further include connectivity support indicator (also referred to as IAB support indicator or IAB support information or connectivity support information) for indicating whether the mIAB node can support network connectivity for a wireless communication device (such as a UE or another IAB node). The ability of the mIAB node to support network connectivity for other wireless communication devices (e.g. whether a reliable radio link can be established and maintained between the mIAB node and other wireless communication devices) will depend on the mobility of the mIAB node (e.g. the mobility capability and/or current mobility status of the mIAB node). In some cases, the movement of the mIAB node may mean the mIAB node cannot support network connectivity. In an example, when the mIAB node can support network connectivity, the mIAB node sets or enables a connectivity support indicator or IAB or connectivity support information by including IAB support information or connectivity support information in the mobility information message (e.g. in a field of the mobility information message) to indicate network connectivity can be supported by the mIAB node. The IAB or connectivity support information may include information indicating the mIAB node can support network connectivity and/or the cell associated with the mIAB node can be considered as a candidate for cell (re)selection. When the mIAB node cannot support network connectivity, the mIAB node does not set or disables a connectivity support indicator or IAB or connectivity support information by not including IAB support information or connectivity support information in the mobility information message to indicate network connectivity cannot be supported by the mIAB node. For example, when the mIAB node can support network connectivity, a field indicating both the support by the mIAB node and the cell status is included in the mobility information message and when the mIAB node cannot support network connectivity and/or the cell associated with the mIAB node is barred for the wireless communication device, the field is not included. The presence or absence of the field in the mobility information message provided by the mIAB node therefore indicates whether the network connectivity is supported or not respectively. In other words, the mIAB node performs conditional IAB support management to determine whether the mIAB node can support network connectivity and includes or does not include IAB support information in the mobility information message based on the determination. In an alternative arrangement, the mobility information message may include a connectivity support indicator that may be set to one value indicating the mIAB node cannot support network connectivity and to another value indicating the mIAB node can support network connectivity.

The mIAB node may determine whether or not it can support network connectivity, and so whether or not the mIAB node is to set the connectivity support indicator or IAB support information or connectivity support information, based on the mobility of the mIAB node (e.g. based on the mobility capability of the mIAB node (e.g. as indicated in the mobility profile information of the mIAB node), and/or guaranteed static time information and/or current mobility status of the mIAB node). As discussed above, the mobility profile information and/or guaranteed static time information, and any subsequent updates if required, may be stored in the IAB node (e.g. on setup or subsequently) and used to determine whether the IAB node can support network connectivity.

In another arrangement, an IAB donor node (such as IAB donor CU 401) connected to the IAB node (e.g. IAB node 470 which is managed by IAB donor CU 401) may determine whether or not the mIAB node can support network connectivity, and so whether or not the mIAB node is to set the connectivity support indicator or IAB support information or connectivity support information (e.g. include the field with the IAB or connectivity support information in the mobility information message or not), based on mobility of the mIAB node. The IAB donor node can determine mobility of the mIAB node based on mobility information (such as mobility profile information and/or guaranteed static time information) received from the mIAB node. The mobility information may be provided to the IAB donor node by the mIAB node, at IAB node setup or subsequently, in a mobility indication message as discussed above and based on the mobility information provided in the mobility indication message, the IAB donor node can determine whether the mIAB node can support network connectivity and can send a connectivity or IAB support configuration message (e.g. a RRC reconfiguration message as discussed below with reference to FIG. 5) indicating whether the mIAB node can support network connectivity to the mIAB node. The mIAB node can then determine whether or not it can support network connectivity and so whether or not the mIAB node is to set the connectivity support indicator or IAB support information or connectivity support information based on the received connectivity or IAB support configuration message.

In response to determining the mIAB node can support network connectivity, the mIAB node may provide a mobility information message including IAB support information to indicate network connectivity for a wireless communication device can be supported by the IAB node.

In an example, when either the mIAB node or the IAB donor node determines the mIAB node is or will be static for a time period greater than a certain threshold (e.g. the threshold may be as low as a few tens of seconds) or when the mIAB node is moving with limited mobility, it is determined that the mIAB node can support network connectivity. The mobility of the mIAB node is limited when at least one of the following criteria or conditions is met: the speed of the mIAB node is below a certain threshold (for example, the actual speed of the mIAB node (e.g. as indicated by the mobility status indication information, or the speed-related information in the mobility profile information) is below a predefined threshold); the mobility area in which the mIAB node is moving or will move is geographically limited; the mobility area is within one topology or one network cell (e.g. information in the mobility profile information indicates that the mIAB node remains under the same topology or the same network cell). A mobility area being geographically limited may include an area in which the mIAB node is moving or will move and the size of which is below a certain or predefined threshold, or may include an area having a type or category which belongs to a type or category that is considered as being geographically limited (i.e. having a size that is below a certain threshold). Such a type or category with limited size may include a car park.

In another example, when it is determined that the mIAB node is moving or is a mobile node (i.e. with the ability to move), it is determined that the mIAB node cannot support network connectivity.

The mobility information message may further include at least one of: mobile node indication information indicating whether the mIAB node is a mobile IAB node; mobility status indication information indicating a current status of mobility of the mIAB node; mobile IAB cell indication information for indicating a cell associated with a mobile IAB node (e.g. a cell ID may be included in the mobility information message). The current status of mobility may include whether the mIAB node is moving currently or is stationary, and may also include additional information relating to the nature of the movement such as the current speed, and/or whether the mIAB node is accelerating or decelerating, etc.

More details regarding the mobility indication message sent to the IAB donor node and the mobility information message sent to other IAB nodes or UEs are given below.

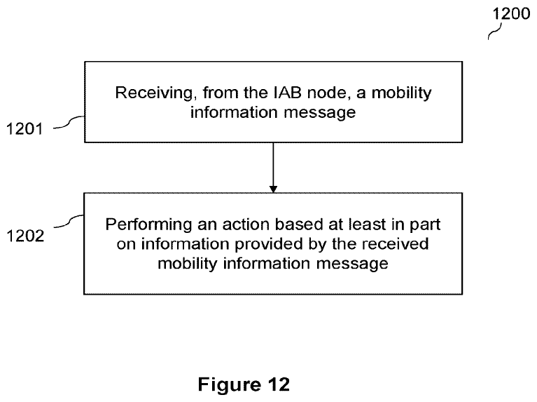

Referring now also to FIG. 12 which shows steps of an example method 1200, in accordance with an embodiment of the present invention, performed at a wireless communication device on receipt of a mobility information message sent by an IAB node of a wireless communication system, with the IAB node being controlled by a IAB donor node. Method 1200 can be used to manage network connectivity in a wireless communication system including at least one a mobile Integrated Access and Backhaul, (mIAB). The wireless communication device performing method 1200 may be another IAB node in the wireless communication system or a UE, either of which may be operating in the vicinity of the IAB node so they receive the mobility information message. For example, with reference to the wireless communication system shown in and described with respect to FIG. 4, the wireless communication device performing the method 1200 may be the IAB node 460 of IAB topology 4001 controlled by the IAB donor CU 401 or IAB node 440 of IAB topology 4002 controlled by the IAB donor CU 402, or UE 390 and the IAB node providing the mobility message may be the mobile IAB node, IAB node 470 controlled by the IAB donor CU 401. The method 1200 as shown in and described with respect to FIG. 12 may be performed by software elements and/or hardware elements. The wireless communication device performing the method 1200 may be implemented in a communication device 1000 as shown in and described with reference to FIG. 10 with the method as shown in and described with respect to FIG. 12 being performed by one or more processing units, such as the central processing unit 1011.

Briefly, at step 1201 the wireless communication device receives a mobility information message from the IAB node. The wireless communication device then performs an action based at least in part on information provided by the received mobility information message, at step 1202. The IAB node sending the mobility information message may be a mobile IAB node or a fixed IAB node (in the sense that the IAB node is fixed at one location).

When the IAB node is a mobile IAB node, mIAB node, the mobility information message includes at least one of: mobility profile information indicating the mobility capability of the IAB node; guaranteed static time information indicating a minimum time period for which the IAB node remains at a certain location. The mobility profile information may include at least one of the following: speed information indicating a speed capability of the IAB node, range information indicating a mobility area of the IAB node, static information indicating a duration of one or more static periods the IAB node may experience, itinerary information indicating a sequence of mobility and static periods for an itinerary the IAB node may follow. The mobility information message may further include at least one of: mobile node indication information indicating whether the IAB node is a mobile IAB node; mobility status indication information indicating a current status of mobility of the IAB node; mobile IAB cell indication information for indicating a cell is associated with a mobile IAB node (e.g. a cell ID is included in the mobility information message); IAB support information or connectivity support information (also referred to as connectivity indicator) for indicating whether the IAB node can support network connectivity for a wireless communication device (such as a UE or another IAB node). More details of the mobility information included in the mobility information message provided by the IAB node and received at the wireless communication device is given above in relation to FIG. 11.

When the IAB node is a fixed IAB node, the mobility information message may include mobile node indication information indicating the IAB node is not a mobile IAB node.

On receipt of the mobility information provided in the mobility information message, the UEs and/or other IAB nodes can determine how to act based on the mobility of the mIAB node as indicated by the provided mobility information. With additional information regarding the mobility capability of the mIAB node and/or the guaranteed static time information, the UEs and/or other IAB nodes have additional information and so can act more effectively as discussed above.

In an example, performing an action at step 1202 may include determining whether to initiate a connection establishment procedure or set up procedure for establishing a connection to a network (e.g. IAB network system of FIG. 4 or NG RAN) via or through the IAB node, such as RRC connection establishment procedure, based on the mobility information message. The wireless communication device may determine not to initiate a connection establishment procedure when information provided by the mobility information message indicates the IAB node is a mobile IAB node. The wireless communication device may determine to initiate a connection establishment procedure when information provided by the mobility information message indicates certain criteria are met. The certain criteria including: 1) the IAB node is not a mobile IAB node; 2) the IAB node is a mobile IAB node and is static or will be static for a time period greater than a certain threshold; 3) the IAB node is a mobile IAB node and is moving with limited mobility. As discussed above, the criteria for limited mobility includes the speed of the mIAB node is below a certain threshold; the mobility area is geographically limited; the mobility area is within one topology or one network cell.

When the wireless communication device determines that a connection establishment procedure is to be initiated, performing an action at step 1202 may further include sending a request to the IAB donor node (e.g. IAB donor CU 401) via the IAB node (e.g. IAB node 470) for requesting establishment of a connection via the IAB node (IAB node 470). The request is sent as part of the connection establishment procedure, such as a RRC connection establishment procedure. When the wireless communication device is an UE (such as UE 390), the requested connection is with the IAB topology of the IAB node (IAB node 470) which is managed by the IAB donor node (e.g. topology 4001 managed by donor CU 401) and when the connection procedure is complete, the UE will be connected to the IAB node (IAB node 470) via a communication link or radio link. When the wireless communication device is an IAB node (such as IAB node 460), the requested connection is with the IAB topology of the IAB node (IAB node 470) which is managed by the IAB donor node (e.g.

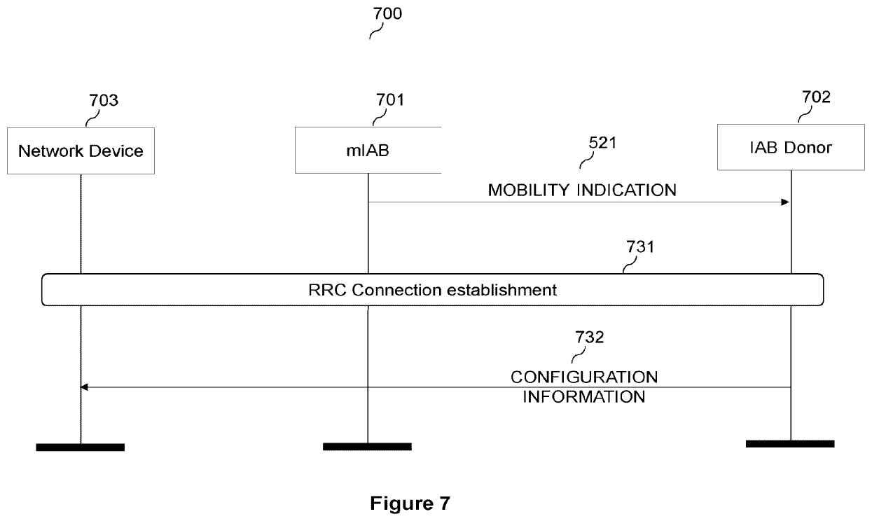

topology 4001 managed by donor CU 401) and when the connection procedure is complete, the IAB node (such as IAB node 460) or other IAB node will be connected to the IAB node (IAB node 470) via a Backhaul (BH) communication link or BH link. In response to the request, the wireless communication device receives a configuration message from the IAB donor node (e.g. donor CU 401). For example, the configuration message, received at the wireless communication device (UE or IAB node), indicating the connection via the IAB node has been accepted may be the RRCSetup message or the configuration message indicating the connection via the IAB node has been rejected may be the RRCReject message, instead of an RRCSetup message, as specified in 3GPP TS 38.331. In the case where the wireless communication device is an IAB node (such as IAB node 460) and after the IAB node 460 is connected to the IAB node 470, the configuration message may indicate the BH link between the IAB node and the mobile IAB node has been rejected or configured and in this case, the configuration message may be a RRCReconfiguration message, as defined in 3GPP TS 38.331 (such as the CONFIGURATION INFORMATION message 732 as described in FIG. 7).

In an example, when the connection via the IAB node has been rejected because the IAB node is a mobile IAB node or the cell associated with the IAB node (or requested connecting cell) is a mobile cell, the configuration message includes IAB configuration rejection cause information indicating why the connection has been rejected (e.g. indicating the connection has been rejected because the IAB node is a mobile IAB node or because the cell associated with the IAB node (or requested connecting cell) is a mobile cell). As discussed below in more detail with respect to FIG. 7, when a UE has sent a request to establish a connection via the IAB node as part of a connection establishment procedure, the rejection cause information may include MobileCellConnectionReject, or Mobile Cell connection rejection information which indicates to the UE that a connection request is rejected because the UE tried to connect to the network via a mobile IAB node. As discussed below in more detail with respect to FIG. 7, when a IAB node has sent a request to establish a connection via the IAB node as part of a connection establishment procedure, the rejection cause information may include iab-configRejectCause, or IAB configuration Rejection Cause information. The configuration message may further include IAB configuration rejection information indication the connection has been rejected.

When the connection via the IAB node has been accepted, the configuration message includes IAB configuration acceptance information indication the connection has been accepted. When the IAB node is a mobile IAB node, irrespective of whether the connection via the IAB node has been accepted or rejected, the configuration message may include mobility profile information indicating the mobility capability of the IAB node. Details of the mobility profile information have been discussed above. Such cause information, and if provided, the mobility profile information, can help the wireless communication device determine efficiently what to do next: for example, select an alternative IAB node via which to try and establish a connection without using resources to try again to connect with the mobile IAB node or if the provided information indicates the mobile IAB node will be moving slowly or within a limited area, the wireless communication device may try again to establish a connection via the mobile IAB node.

When the IAB node is a mobile IAB node and the wireless communication device is another IAB node (e.g. a child IAB node), the configuration message may further include mobile parent IAB node indication information indicating the parent IAB node is a mobile IAB node and the associated cell is a mobile cell.

When the wireless communication device is another IAB node (i.e. a child IAB node) connected to the IAB node (i.e. a parent IAB node), for example, the MT part of IAB node 460 is connected to the DU part of IAB node 470 following completion of a connection establishment procedure, performing an action may comprise providing a mobility capability message (such as the MOBILITY INFORMATION message 541 discussed below with reference to FIG. 5) including information indicating the mobility capability of the IAB node based on information provided by the received mobility information message received from the IAB node. The mobility capability message including information indicating the mobility capability of the IAB node based on information provided by the received mobility information message received from the IAB node. The mobility capability message may be sent to all nodes (e.g. UEs and IAB nodes) in the vicinity of the child IAB node (for example, via broadcast). The mobility capability message may include all or some of the information received from the IAB node in the mobility information message, such as the mobility profile information and/or the guaranteed static time information, and/or mobile node indication information and/or mobility status indication information and/or IAB support information etc. as discussed above. In addition, the mobility capability message may further include identifier information for identifying the IAB node, such as the unique BAP address of the IAB node. If the IAB node is a boundary node, the BAP address included in the mobility capability message is the BAP address configured by the IAB donor CU controlling the child IAB node (i.e. the BAP address for the same topology to which the child IAB node belongs).

When the wireless communication device is another IAB node (i.e. a child IAB node) connected to the IAB node (i.e. a parent IAB node), for example, the MT part of IAB node 460 is connected to the DU part of IAB node 470 following completion of a connection establishment procedure, performing an action may comprise determining a Radio Link Failure, RLF, for a radio link (i.e. BH link) with the parent IAB node, based on information provided by the received mobility information message and sending a RLF indication message. The RLF indication message includes information indicating the cause of RLF is related to mobility of the parent IAB node. For example, the information provided by the received mobility information message may indicate that the parent IAB node is a mobile IAB node or has recently become a mobile IAB node or was previously a mobile IAB node but has recently changed its mobility status or capability (e.g. is moving out of range) such that RLF occurs on the BH link between the child IAB node and the parent IAB node. The RLF indication message will be received by the child IAB node(s) of the child IAB node (which is now acting as a parent) and the child IAB node(s) can act accordingly.

Another example method, in accordance with an embodiment of the present invention, performed at a wireless communication device of a wireless communication system will now be described. The wireless communication system further comprises an IAB node controlled by an IAB donor node. As with the previous methods, this method can be used to manage network connectivity in a wireless communication system including at least one mobile Integrated Access and Backhaul, (mIAB) node. The wireless communication device may be another IAB node in the wireless communication system or a UE. The wireless communication device decides to initiate a connection establishment procedure to connect to a network (e.g. IAB network system of FIG. 4 or NG RAN) via the IAB node: for example, the wireless communication device is either operating in the vicinity of the IAB node or at some time previously was operating in the vicinity of the IAB node which has now moved.

For example, with reference to the wireless communication system shown in and described with respect to FIG. 4, the wireless communication device may be the IAB node 460 of IAB topology 4001 controlled by the IAB donor CU 401 or IAB node 440 of IAB topology 4002 controlled by the IAB donor CU 402 or UE 390 and the IAB node via which the wireless communication device wishes to connect may be the mobile IAB node, IAB node 470 controlled by the IAB donor CU 401. The method may be performed by software elements and/or hardware elements. The wireless communication device performing the method may be implemented in a communication device 1000 as shown in and described with reference to FIG. 10 with the method being performed by one or more processing units, such as the central processing unit 1011.

The wireless communication device sends a request to the IAB donor node (e.g. IAB donor CU 401) via the IAB node (e.g. IAB node 470) for requesting establishment of a connection via the IAB node (IAB node 470). The request is sent as part of the connection establishment procedure, such as a RRC connection establishment procedure. In response to the request, the wireless communication device receives a configuration message from the IAB donor node (e.g. donor CU 401). As discussed below, the configuration message may be a RRCSetup message or RRCReject message or a RRCReconfiguration message. In an example, when the connection to the IAB node has been rejected, the configuration message includes IAB configuration rejection cause information indicating why the connection has been rejected (e.g. indicating the connection has been rejected because the IAB node is a mobile IAB node or the cell associated with the IAB node (or requested connecting cell) is a mobile cell). As discussed below in more detail with respect to FIG. 7, when a UE has sent a request to establish a connection via the IAB node as part of a connection establishment procedure, the rejection cause information may include MobileCellConnectionReject, or Mobile Cell connection rejection information which indicates to the UE that a connection request is rejected because the UE tried to connect to the network via a mobile IAB node. As discussed below in more detail with respect to FIG. 7, when a IAB node has sent a request to establish a connection via the IAB node as part of a connection establishment procedure, the rejection cause information may include iab-configRejectCause, or IAB configuration Rejection Cause information. The configuration message may further include IAB configuration rejection information indication the connection has been rejected.

When the connection to the IAB node has been accepted, the configuration message includes IAB configuration acceptance information indicating the connection has been accepted (e.g. the BH link configured). When the IAB node is a mobile IAB node, irrespective of whether the connection to the IAB node has been accepted or rejected, the configuration message may include mobility profile information indicating the mobility capability of the IAB node. Details of the mobility profile information have been discussed above. The benefits of providing such cause information, and if provided, the mobility profile information, are discussed above.

When the IAB node is a mobile IAB node and the wireless communication device is another IAB node (e.g. a child IAB node), the configuration message may further include mobile parent IAB node indication information indicating the parent IAB node is a mobile IAB node and the associated cell is a mobile cell.

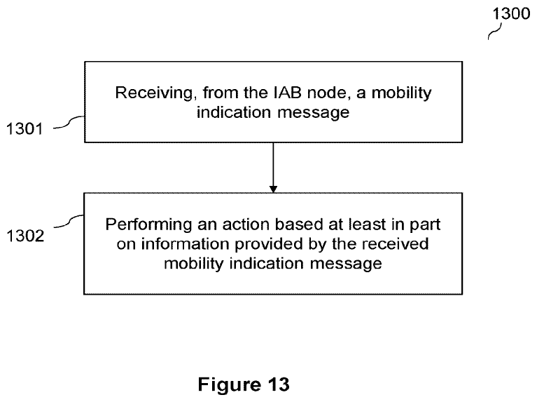

Referring now also to FIG. 13 which shows steps of an example method 1300, in accordance with an embodiment of the present invention, performed at an IAB donor node of a wireless communication system on receipt of a mobility indication message sent by an IAB node, with the IAB node being connected to the IAB donor node. The IAB donor node may be an IAB donor CU that is connected to and controlling the IAB node (such as IAB donor CU 401 which controls IAB node 470) or when the IAB node acts as a boundary node, the IAB donor CU could be one or more IAB donor CUs to which the IAB node is connected (such as IAB donor CUs 401 and/or 402 which are both connected to the IAB node 470 when the IAB node 470 acts as a boundary node). Method 1300 can be used to manage network connectivity in a wireless communication system including at least one a mobile Integrated Access and Backhaul, (mIAB). The IAB donor node may be an IAB donor CU. For example, with reference to the wireless communication system shown in and described with respect to FIG. 4, the IAB donor node may be IAB donor CU 401 and the IAB node may be IAB node 470 controlled by the IAB donor CU 401. The method 1300 as shown in and described with respect to FIG. 13 may be performed by software elements and/or hardware elements. The IAB donor node performing the method 1300 may be implemented in a communication device 1000 as shown in and described with reference to FIG. 10 with the method as shown in and described with respect to FIG. 13 being performed by one or more processing units, such as the central processing unit 1011.

Briefly, at step 1301, the IAB donor node receives a mobility indication message from the IAB node. The IAB donor node then performs an action based at least in part on information provided by the received mobility indication message, at step 1302. The mobility indication message is received at the CU part of the IAB donor node (i.e. IAB donor CU) and the IAB donor CU performs the action. For example, the IAB donor CU 401 receives the mobility indication message from IAB node 470.

The mobility indication message includes at least one of: mobility profile information indicating the mobility capability of the IAB node; guaranteed static time information indicating a minimum time period for which the IAB node remains at a certain location. The mobility profile information may include at least one of the following: speed information indicating a speed capability of the IAB node, range information indicating a mobility area of the IAB node, static information indicating a duration of one or more static periods the IAB node may experience, itinerary information indicating a sequence of mobility and static periods for an itinerary the IAB node may follow.

The mobility indication message may further include at least one of: mobile node indication information indicating whether the IAB node is a mobile IAB node; mobility status indication information indicating a current status of mobility of the IAB node. More details of the information (e.g. the mobility profile information, the guaranteed static time information etc.) included in the mobility indication message provided by the IAB node and received at the IAB donor node is given above in relation to FIG. 11.

On receipt of the mobility information provided in the mobility indication message, the IAB donor node or IAB donor CU can determine how to act based on the mobility of the IAB node as indicated by the provided mobility information. With additional information regarding the mobility capability of the IAB node and/or the guaranteed static time information, the IAB donor node has additional information and so can act more effectively as discussed above.

In an example, performing an action at step 1302 may include sending, by the IAB donor node a notification message for indicating the IAB node is a mobile IAB node based on information provided in the mobility indication message to one or more of the following:

another IAB node (e.g. IAB node 430); a UE (e.g. UE 390); a CU of an IAB donor node of another IAB topology which is different to the topology controlled by the IAB donor node (e.g. IAB donor CU 401 sends a notification to IAB donor CU 402 of IAB topology 4002). By sending the notification, the IAB donor node can provide information regarding the mobility of the IAB node to other wireless communication devices in the wireless communication system which can help the other devices act accordingly. By providing the notification message indicating the mobility of the IAB node to the CU of the IAB donor node (e.g. IAB donor CU 402) of another IAB topology, if the IAB node moves into the coverage of the another IAB topology (e.g. IAB node 470 moves into the coverage of IAB topology 4002), the mobility information can be used by the IAB donor CU of the another topology to manage the migration of the IAB node to the another topology.

The IAB donor node may receive the mobility indication message as part of an IAB node setup procedure with the IAB node (for example, a RRC connection establishment procedure as specified in 3GPP TS 38.331 or a F1 setup procedure, as discussed below in more detail with respect to FIGS. 5 and 6). Alternatively or additionally, the IAB donor node may receive the mobility indication message in response to a message sent by the donor IAB node. For example, the IAB donor node may send a request for up-to-date mobility status information and the mobility indication message including up-to-date mobility status information (e.g. up-to-date mobility profile information and/or guaranteed static time information and may also include mobility status indication information) is provided in response to the request as discussed in more detail below. Alternatively or additionally, the IAB donor node may receive the mobility indication message in response to the IAB node determining a change in mobility (e.g. there is a change in mobility status, such as a change of speed, etc. and/or there is change in the mobility profile information, such as a change in itinerary, etc. and/or there is a change in guaranteed static time information). Alternatively or additionally, the IAB donor node may receive the mobility indication message from the IAB node periodically, with the time between receipt of the mobility indication message being the same or variable.

In an example, when the mobility indication message is received as part of an IAB node setup procedure, the IAB donor node completes the IAB node setup procedure with the IAB node. The information provided in the mobility indication message is stored by the IAB donor node for the IAB node. On receipt, subsequently, of a request from a wireless communication device, which may be a UE or another IAB node, to establish a connection via the IAB node as part of a connection establishment procedure (e.g. a RRC connection establishment procedure), performing an action 1302 may comprise determining whether to accept or reject (i.e. allow or not allow) the connection via the IAB node based at least in part on mobility of the IAB node. In response to determining whether to accept or reject the connection request, the IAB donor node then sends to the wireless communication device (e.g. UE or another IAB node) a configuration message indicating whether the connection with the IAB node has been accepted or rejected. For example, the configuration message indicating the connection via the IAB node has been accepted may be the RRCSetup message or the configuration message indicating the connection via the IAB node has been rejected may be the RRCReject message, instead of an RRCSetup message, as specified in 3GPP TS 38.331. In the case where the wireless communication device is an IAB node (such as IAB node 460) and after the IAB node 460 is connected to the IAB node 470, the configuration message may indicate the BH link between the IAB node and the mobile IAB node has been rejected or configured and in this case, the configuration message may be a RRCReconfiguration message, as defined in 3GPP TS 38.331 (such as the CONFIGURATION INFORMATION message 732 as described in FIG. 7).

The IAB donor node may determine whether to accept or reject the connection via the IAB node based on information provided by the mobility indication message received at the IAB donor node (e.g. received as part of a setup procedure or received subsequently). As discussed above, the mobility indication message includes mobility profile information and/or guaranteed static time information which information can be used to determine whether the connection is to be accepted or rejected. For example, the IAB donor node can make a determination based on the mobility profile information. The mobility indication message (e.g. received as part of a setup procedure or received subsequently, such as received in response to a request from the IAB donor CU, received periodically from the IAB node, received when the IAB node detects a change in mobility of the IAB node, such as change in mobility status and/or mobility capability) may additionally include mobility status information which indicates the current status of mobility of the IAB node and in which case, the IAB donor node may determine whether to accept or reject the connection via the IAB node based on the current status of mobility of the IAB node. In an example, the IAB donor node may determine whether to accept or reject the connection via the IAB node based on the current status of mobility of the IAB node and the mobility capability of the IAB node as indicated by the mobility profile information. The IAB donor node may determine to reject a connection request when the IAB node is a mobile IAB node or when the IAB node is a mobile IAB node with a mobility capability and/or current mobility status that is likely to cause connection issues (e.g. the area of mobility of the IAB node is large, the average speed is above a threshold, the current speed is above a threshold, etc.).

In an example, when the connection via the IAB node has been rejected based on mobility of the IAB node (e.g. because the IAB node is a mobile IAB node or a cell associated with the IAB node is a mobile cell), the configuration message includes IAB configuration rejection cause information indicating why the connection has been rejected (e.g. indicating the connection has been rejected because the IAB node is a mobile IAB node or a cell associated with the IAB node is a mobile cell). As discussed below in more detail with respect to FIG. 7, when a UE has sent a request to establish a connection via the IAB node as part of a connection establishment procedure, the rejection cause information may include MobileCellConnectionReject, or Mobile Cell connection rejection information which indicates to the UE that a connection request is rejected because the UE tried to connect to the network via a mobile IAB node. As discussed below in more detail with respect to FIG. 7, when a IAB node has sent a request to establish a connection via the IAB node as part of a connection establishment procedure, the rejection cause information may include iab-configRejectCause, or IAB configuration Rejection Cause information. The configuration message may further include IAB configuration rejection information indication the connection has been rejected.

When the connection via the IAB node has been accepted, the configuration message includes IAB configuration acceptance information indication the connection has been accepted. When the IAB node is a mobile IAB node, irrespective of whether the connection via the IAB node has been accepted or rejected, the configuration message may include mobility profile information indicating the mobility capability of the IAB node. Details of the mobility profile information have been discussed above. The benefits of providing such cause information, and if provided, the mobility profile information, are discussed above.

When the IAB node is a mobile IAB node and the wireless communication device is another IAB node (e.g. a child IAB node), the configuration message may further include mobile parent IAB node indication information indicating the IAB node is a mobile parent IAB node and the associated cell is a mobile cell.

In an example, performing an action 1302 by the IAB donor node may comprise determining whether to enable or disable network connectivity support by the IAB node based at least in part on mobility of the IAB node and sending, to the IAB node, a connectivity or IAB support configuration message (e.g. a RRC reconfiguration message as discussed below with reference to FIG. 5) for indicating whether the IAB node can support or not network connectivity for a wireless communication device based on the determining.

The wireless communication device may be a UE or another IAB node. The IAB donor node may make the determination based on information provided by the mobility indication message. In an example, the IAB donor node may make the determination based on the current status of mobility of the IAB node (if the information is included in the mobility indication message) and/or the mobility capability of the IAB node as indicated by the mobility profile information and/or the guaranteed static time information. More details of the connectivity or IAB support configuration message are discussed above with reference to FIG. 11.

The IAB donor node may determine to disable network connectivity support when the IAB node is a mobile IAB node or when the IAB node is a mobile IAB node with a mobility capability and/or current mobility status that is likely to cause connection issues (e.g. the area of mobility of the IAB node is large, the average speed is above a threshold, the current speed is above a threshold, etc.). The IAB donor node may determine to enable network connectivity support when the IAB node is static or will be static for a time period greater than a certain threshold or when the IAB node is moving with limited mobility. In an example, the mobility of the IAB node is limited when at least one of the following criteria or conditions is met: the speed of the IAB node is below a certain threshold; the mobility area is geographically limited; the mobility area is within one topology or one network cell. See above (e.g. the description of FIG. 11) for more details of the limited mobility criteria.

In an example where the IAB donor node receives a new mobility indication message including updated information compared to a previously received mobility indication message (e.g. the mobility profile information has been updated and/or mobility status information indicating a current status of mobility of the IAB node), performing an action may comprise: determining whether one or more wireless communication devices (e.g. one or more UEs and/or one or more other IAB nodes) connected to the IAB node should be released based on information provided by the new mobility indication message and sending a release notification to the one or more wireless communication devices in response to determining the one or more wireless communication devices should be released.

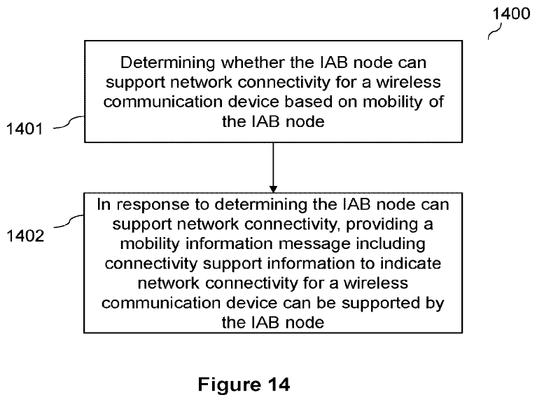

FIG. 14 shows steps of an example method 1400 for use in managing network connectivity, in a wireless communication system including at least one Integrated Access and Backhaul, (IAB), node of a wireless communication system, in accordance with an embodiment of the present invention. The method 1400 of FIG. 14 is performed at the IAB node. For example, with reference to the wireless communication system shown in and described with respect to FIG. 4, the IAB node performing the method 1400 may be the IAB-node 470 of IAB topology 4001 controlled by the IAB donor CU 401. The method 1400 as shown in and described with respect to FIG. 14 may be performed by software elements and/or hardware elements. The IAB node may be implemented in a communication device 1000 as shown in and described with reference to FIG. 10 with the method as shown in and described with respect to FIG. 14 being performed by one or more processing units, such as the central processing unit 1011.

Briefly, at step 1401, the IAB node (e.g. IAB node 470) determines whether the IAB node can support network connectivity for a wireless communication device (e.g. another IAB node or a UE) based on the mobility of the IAB node. In response to determining the IAB node can support network connectivity, at step 1402, the IAB node provides a mobility information message including IAB support information or connectivity support information (also referred to as IAB support indicator) to indicate network connectivity for a wireless communication device (such as a UE or another IAB node) can be supported by the IAB node. As discussed above with reference to FIG. 11, the ability of the IAB node to support network connectivity for other wireless communication devices (e.g. whether a reliable radio link can be established and maintained between the IAB node and other wireless communication devices) will depend on the mobility of the IAB node (e.g. the mobility capability and/or current mobility status of the IAB node). The mobility information message may be provided to or sent to one or more wireless communication devices such as one or more other IAB nodes or one or more UEs. For example, the mobility information message may be broadcast in a SIB1 message.

The mobility information message may further include at least one of: mobility profile information indicating the mobility capability of the IAB node; guaranteed static time information indicating a minimum time period for which the IAB node remains at a certain location; mobile node indication information indicating whether the IAB node is a mobile IAB node; mobility status indication information indicating a current status of mobility of the IAB node; mobile IAB cell indication information for indicating a cell is associated with a mobile IAB node (e.g. a cell ID may be included in the mobility information message). In an example, the mobility profile information may include at least one of the following: speed information indicating a speed capability of the mIAB node, range information indicating a mobility area of the mIAB node, static information indicating a duration of one or more static periods the mIAB node may experience, itinerary information indicating a sequence of mobility and static periods for an itinerary the mIAB node may follow. More details regarding the mobility information message sent to other IAB nodes or UEs are given above with respect to FIG. 11.

In an example, when the IAB node can support network connectivity, the IAB node sets or enables IAB support information or connectivity support information or connectivity support indicator by including IAB support information or connectivity support information in the mobility information message (e.g. in a field of the mobility information message) to indicate network connectivity can be supported by the IAB node. The IAB support information or connectivity support information may include information indicating the IAB node can support network connectivity and/or the cell associated with the IAB node can be considered as a candidate for cell (re)selection. When the IAB node cannot support network connectivity, the IAB node does not set or disables IAB support information or connectivity support information or connectivity support indicator of the mobility information message by not including IAB support information or connectivity support information in the mobility information message to indicate network connectivity cannot be supported by the IAB node. For example, when the IAB node can support network connectivity, a field indicating both the support by the IAB node and the cell status is included in the mobility information message and when the IAB node cannot support network connectivity and/or the cell associated with the IAB node is barred for the wireless communication device, the field is not included. The presence or absence of the field in the mobility information message provided by the IAB node therefore indicates whether the network connectivity is supported or not respectively. In an alternative arrangement, the mobility information message may include a connectivity support indicator that may be set to one value indicating the mIAB node cannot support network connectivity and to another value indicating the mIAB node can support network connectivity.

The IAB node may determine whether or not it can support network connectivity based on the mobility of the IAB node (e.g. based on the mobility capability of the IAB node (e.g. as indicated in the mobility profile information of the IAB node), and/or guaranteed static time information and/or current mobility status of the IAB node. As discussed above, the mobility profile information and/or guaranteed static time information, and any subsequent updates if required, may be stored in the IAB node (e.g. on setup or subsequently) and used to determine whether the IAB node can support network connectivity.

In another example, the IAB node (e.g. IAB node 470) may receive, from a donor CU node (e.g. IAB donor CU 401) connected to the IAB node (e.g. the IAB donor CU that controls the IAB node), a connectivity or IAB support configuration message (e.g. in a RRC reconfiguration message as discussed below with reference to FIG. 5) indicating whether the IAB node can support network connectivity. The IAB node determines whether the IAB node can support network connectivity based on the received connectivity or IAB support configuration message. In this example, an IAB donor node (such as IAB donor CU 401) connected to the IAB node (e.g. IAB node 470 which is managed by IAB donor CU 401) may determine whether or not the IAB node can support network connectivity, and so whether or not the IAB node is to include the connectivity support information in the mobility information message (e.g. to include the field in the mobility information message or not) based on mobility of the IAB node. For example, as discussed above with reference to FIG. 11 and/or FIG. 13, the IAB donor node (e.g. IAB donor CU 401) can determine mobility of the IAB node based on mobility information (such as mobility profile information and/or guaranteed static time information) received from the IAB node. The mobility information may be provided to the IAB donor node by the IAB node, at IAB node setup or subsequently, in a mobility indication message sent by the IAB node to the IAB donor node as discussed above and based on the mobility information provided in the mobility indication message, the IAB donor node can determine whether the IAB node can support network connectivity or not.

In an example, when the IAB node determines the IAB node is or will be static for a time period greater than a certain threshold or when the IAB node is moving with limited mobility, the IAB node determines that the IAB node can support network connectivity. The mobility of the IAB node is limited when at least one of the following criteria or conditions is met: the speed of the IAB node is below a certain threshold; the mobility area is geographically limited; the mobility area is within one topology or one network cell. See above (e.g. the description of FIG. 11 and/or FIG. 13) for more details of the limited mobility criteria.

In another example, when it is determined that the mIAB node is moving or is a mobile node (i.e. with the ability to move), it is determined that the mIAB node cannot support network connectivity.

When it is determined that the mIAB node cannot support network connectivity, although the IAB support information may be disabled or not set in the mobility information message (e.g. the IAB support information is not include in the mobility information message), the mobility information message may still include at least one of: the mobility profile information; the guaranteed static time information; the mobile node indication information; the mobility status indication information; the mobile IAB cell indication information.

Referring now also to FIG. 5 which is a schematic and simplified diagram illustrating some example message flows for use in managing network connectivity, in a wireless communication system including at least one IAB node, in accordance with one or more embodiments of the invention and which can be used for managing the advertising by an IAB node of its mobility capability and status along with its ability to support IAB connection with a child IAB node.

According to an example, a mobile IAB node 501 (which may correspond to IAB node 123 of FIG. 1 and IAB node 470 of FIG. 4 as described above) may share some mobility information with its IAB Donor 502 (which may correspond to IAB donor node 120 of FIG. 1 and IAB donor CU 401 of FIG. 4) by sending a MOBILITY INDICATION message 521. MOBILITY INDICATION message 521 is an example of the mobility indication message discussed above with reference to FIGS. 11-14.

According to one example, this mobility information sharing may be performed upon mobile IAB node 501 setup. According to another example, the mobility information sharing may be performed on purpose. In this respect, it may be triggered by a change in the mobility status of the mobile IAB node 501 or may be performed on a periodic basis or may be performed upon request from the IAB Donor 502 (e.g. IAB donor CU 401).

In case the mobility information sharing is performed upon mobile IAB node setup and according to one example, such mobility information sharing is performed upon RRC connection establishment and the MOBILITY INDICATION message 521 is the RRCSetupComplete message used to complete the RRC connection establishment process, as specified in 3GPP TS 38.331.

In case the mobility information sharing is performed upon mobile IAB node setup and according to another example, the aforementioned mobility information sharing is performed as part of the F1 setup procedure and the MOBILITY INDICATION message 521 is the FI SETUP REQUEST message, as specified in 3GPP TS 38.473.

In case the mobility information sharing is performed on purpose and according to one example, the MOBILITY INDICATION message 521 is any one of the MeasurementReport, FailureInformation, IABOtherInformation or UEInformationResponse messages, as specified in 3GPP TS 38.331, or the GNB-DU CONFIGURATION UPDATE message, as specified in 3GPP TS 38.473.

According to one example, the MOBILITY INDICATION message 521 includes all or part of the following IAB node mobility information (e.g. information indicating mobility of the IAB node):
mobileiab-NodeIndication, or mobile IAB node indication information (also referred to as mobile node indication information). This information is used to indicate that the device that is sending the MOBILITY INDICATION message 521 is a mobile IAB-node (i.e. an IAB-node having mobility capability) and, in case of connection establishment, that the connection is being established by a mobile IAB-node;
mobility-StatusIndication, or mobility status indication information. This information is used to indicate the current status of mobility of the mobile IAB node such as whether a mobile IAB-node is currently moving or not. This information may also include additional information related to the nature of the movement, e.g. the speed of the mobile IAB node;
guaranteedStaticTime or guaranteed static time information. This information indicates a minimum guaranteed time period for which a mobile IAB node would remain at a fixed location. For instance, a bus that has previously stopped at a bus station may indicate the remaining time before it moves to the next bus station;
mobility-Profile, or mobility profile information. This information provides indication on the mobility capabilities of the mobile IAB node. The mobility profile information may include at least one of the following information:
   speed-related information or speed information indicating a speed capability of the mobile IAB node, such as minimum speed, average speed, maximum speed.
   information on the mobility area, or mobility range, of the mobile IAB node (e.g. range information indicating a mobility area of the mobile IAB node), such as a type of mobility area, a size of mobility area, or a list gathering the Cell IDs of the several Cells that the mobile IAB node previously visited or may visit. The type (or category) of mobility area can be an indication of the size or nature of the geographical area in which the mobile IAB node may move. For example, the type (or category) of mobility area may indicate the geographical area is a bus route, or a train route, or a car park.
   Information (e.g. static information) indicating the duration of the static period(s) the mobile IAB node may experience, such as a minimum static period duration, average static period duration or maximum static period duration. The static information may also include static position information indicating the location where the mIAB will be static.
   Itinerary information, which would be made of a sequence of mobility and static periods (e.g. indicating a sequence of mobility and static periods for an itinerary the mIAB node may follow). The Itinerary information may include for each of mobility and static periods, the duration of the period as well as the speed of the mobile IAB node during this period.

According to an example, once the mobile IAB node 501 (e.g. IAB node 470) has completed its connection setup process with the IAB Donor 502 (e.g. IAB donor CU 401), the mobile IAB node 501 may provide or send (e.g. via broadcast), for advertising purpose, a MOBILITY INFORMATION message 531 to other wireless communication devices (referred to as network devices in FIG. 5), like Network Device 503, in its vicinity. MOBILITY INFORMATION message 531 is an example of the mobility information message discussed above with reference to FIGS. 11-14.

According to one example, Network Device 503 is an IAB node: such as IAB node 121 or 123 of FIG. 1 and IAB node 430, 450, 460, 480 of FIG. 4.

According to another example, Network Device 503 is a UE, such as UE 135 or 136 of FIG. 1 and UE 390 of FIG. 4.

This MOBILITY INFORMATION message 531 may be sent on a periodic basis.

In one aspect, the MOBILITY INFORMATION message 531 is the SIB1 message, as defined in 3GPP TS 38.331.

According to one example of an embodiment of the invention, the MOBILITY INFORMATION message 531 includes all or part of the following IAB node mobility information:
iab-support, or IAB support information. For example, the IAB support information (or connectivity support information) may indicate whether the IAB node can support network connectivity for a wireless communication device. As defined in 3GPP TS 38.331, this information combines both the support of IAB and the cell status for IAB. If this information is present in the MOBILITY INFORMATION message 531, the cell supports IAB and the cell is also considered as a candidate for cell (re)selection for IAB-node; if the field is absent, the cell does not support IAB and/or the cell is barred for IAB-node.
mobileiab-NodeIndication, or mobile IAB node indication information (also referred to as mobile node indication information). This information is used to indicate that the device that is sending the MOBILITY INFORMATION message 531 is a mobile IAB-node (i.e. an IAB-node having mobility capability) and that the associated cell is a mobile cell.
mobility-StatusIndication, or mobility status indication information. This information is used to indicate the current status of mobility of the mobile IAB node such as whether a mobile IAB-node is currently moving or not. This information may also include additional information related to the nature of the movement, e.g. the speed of the mobile IAB node.
guaranteedStaticTime or guaranteed static time information. This information indicates a minimum guaranteed time period for which a mobile IAB node would remain at a fixed location. For instance, a bus that has previously stopped at a bus station may indicate the remaining time before it moves to the next bus station.
mobility-Profile, or mobility profile information. This information provides indication on the mobility capabilities of the mobile IAB node. The mobility profile information may include at least one of the following information:
   speed-related information or speed information indicating a speed capability of the mobile IAB node, such as minimum speed, average speed, maximum speed.
   information on the mobility area, or mobility range, of the mobile IAB node (e.g. range information indicating a mobility area of the mobile IAB node), such as a type of mobility area, a size of mobility area, or a list gathering the Cell IDs of the several Cells that the mobile IAB node previously visited or may visit. The type (or category) of mobility area can be an indication of the size or nature of the geographical area in which the mobile IAB node may move. For example, the type (or category) of mobility area may indicate the geographical area is a bus route, or a train route, or a car park.
   Information (e.g. static information) indicating the duration of the static period(s) the mobile IAB node may experience, such as a minimum static period duration, average static period duration or maximum static period duration. The static information may also include static position information indicating the location where the mIAB will be static.
   Itinerary information, which would be made of a sequence of mobility and static periods (e.g. indicating a sequence of mobility and static periods for an itinerary the mIAB node may follow). The Itinerary information may include for each of mobility and static periods, the duration of the period as well as the speed of the mobile IAB node during this period.

Based on the IAB node mobility information in a previously received MOBILITY INDICATION message 521, the IAB donor 502 may decide to enable or disable the presence of the iab-support information in the MOBILITY INFORMATION message 531 by sending an IAB SUPPORT CONFIGURATION message 522 to the mobile IAB node 501. IAB SUPPORT CONFIGURATION message 522 is an example of the connectivity or IAB support configuration message discussed above with reference to FIGS. 11-14.

According to an example, the IAB SUPPORT CONFIGURATION message 522 is the RRCReconfiguration message as defined in 3GPP TS 38.331.

According to an example, in case the Network Device 503 is an IAB node connected as a child IAB node to the mobile IAB node 501, the IAB node 503 may also provide or send (e.g. via broadcast), for advertising purpose, a MOBILITY INFORMATION message 541 to some potential IAB nodes (and/or UEs) in its vicinity. The MOBILITY INFORMATION message 541 may include all or part of the IAB node mobility information that was carried by a MOBILITY INFORMATION message 531 previously received from the mobile IAB node 501. In addition, the MOBILITY INFORMATION message 541 may include some information indicating the identifier of the mobile IAB node 501 or identifier information for identifying the IAB node 501, such as a BAP address (as defined in 3GPP TS 38.340). The MOBILITY INFORMATION message 541 is an example of the mobility capability message discussed above with reference to FIG. 12.

According to another example, in case the Network Device 503 is an IAB node connected as a child IAB node to the mobile IAB node 501, an IAB node 503 may experience some Backhaul (BH) Radio Link Failure (RLF), for example when the mobile IAB node 501 is moving too far and going out of range. IAB node 503 may then send an RLF INDICATION message 542 to each of its child IAB nodes, adding some information inside this message to notify the child IAB nodes that the Radio Link Failure results from the mobility of its parent IAB node 501. For example, the RLF INDICATION message 542 may include information indicating the cause of RLF is related to mobility of the parent IAB node.

FIG. 6 illustrates, using a flowchart 600, an example method for managing mobile IAB-node connectivity according to some embodiments of the present invention. The flowchart 600 shows steps performed at the mobile IAB node and the IAB donor node and are examples of steps performed at the mobile IAB node and the IAB donor node as described above with reference to FIGS. 11-14. The method as shown in and described with respect to FIG. 6 may be performed by software elements and/or hardware elements.

The process starts at step 601 where a mobile IAB node, such as mobile IAB node 501 of FIG. 5 and IAB node 470 of FIG. 4, initiates connection setup (e.g. initiates an IAB node setup procedure) with the IAB donor CU (such as IAB donor 502 of FIG. 5 and IAB donor CU 401 of FIG. 4) or detects a change of mobility status and/or capability.

According to an example, at step 601, the mobile IAB node 470 may initiate a connection setup process by sending an RRCSetupRequest message to the IAB Donor CU 401, as part of the RRC connection establishment procedure specified in 3GPP TS 38.331.

According to another example, at step 601, the mobile IAB node 470 may initiate, a connection setup process by sending an F1 SETUP REQUEST message to the IAB Donor CU 401, as part of the F1 Setup procedure specified in 3GPP TS 38.473, used to exchange application level data needed for the gNB-DU and the gNB-CU to correctly interoperate on the F1 interface. According to another example, at step 601, the mobile IAB node 470 may detect a change in its mobility, such as a change in mobility status and/or capability. This change may include a change of speed, a change of its guaranteed static duration, or an update of its mobility profile, as discussed above, for example, in relation with FIG. 5.

At step 601, the mobile IAB node 470 may further send some IAB node mobility information to the IAB Donor (e.g. IAB donor CU 401) through a MOBILITY INDICATION message 521, as discussed, for example, with reference to FIG. 5.

In case the mobile IAB node sent some IAB node mobility information to the IAB Donor through a MOBILITY INDICATION message 521 at step 601, the IAB Donor may, at step 602, determine whether the IAB support or connectivity support by the mobile IAB node should be enabled (e.g. when the IAB node can support network connectivity for a wireless communication device) or be disabled (e.g. when the IAB node cannot support network connectivity for a wireless communication device) and further notify the Mobile IAB node accordingly by sending an IAB SUPPORT CONFIGURATION message 522, as discussed, for example, with reference to FIG. 5. As discussed above, the IAB Donor may determine to disable the IAB support of the IAB node in case the mobile IAB node indication information (mobileiab-NodeIndication) in the MOBILITY INDICATION message 521 sent by the IAB node indicates it is a mobile IAB node. The IAB Donor may determine to enable the IAB support of a mobile IAB node as long as the mobile IAB node is static or will remain static for a significant time duration (i.e. a duration that is above a threshold that may be as low as a few tens of seconds) as determined based on information provided, at step 601, in the MOBILITY INDICATION message 521 (such as, the mobility status indication information and/or the guaranteed static time information).

In an example, the IAB Donor may determine to enable the IAB support of a mobile IAB node regardless of its actual movement, as long as its mobility is limited as determined based on information provided, at step 601, in the MOBILITY INDICATION message 521. See above (e.g. the description of FIG. 11 and/or FIGS. 13 and 14) for more details of the limited mobility criteria/conditions.

At step 603, the mobile IAB node 470 performs conditional IAB support management along with the associated mobility information advertising to potential child IAB nodes (and/or UEs) by providing (e.g. broadcasting) a MOBILITY INFORMATION message 531, as discussed, for example, with reference to FIG. 5. The mobile IAB node 470 may disable the transmission of the IAB support information in the MOBILITY INFORMATION message 531 (e.g. by not including the IAB support information in the MOBILITY INFORMATION message 531) as long as the mobile IAB node is actually moving. The mobile IAB node 470 may enable the advertising of its IAB support information in the MOBILITY INFORMATION message 531 (e.g. by including the IAB support information in the MOBILITY INFORMATION message 531) even though it is currently moving, provided its mobility remains limited. See above (e.g. the description of FIG. 11 and/or FIGS. 13 and 14) for more details of the limited mobility criteria/conditions that the mobile IAB node 470 may consider when determining whether its mobility is limited.

According to another example, the mobile IAB node 470 may determine to enable or disable the advertising of its IAB support information in the MOBILITY INFORMATION message 531 based on the information embedded in an IAB SUPPORT CONFIGURATION message 522 received, at step 602, from the IAB donor (e.g. IAB Donor CU 401) as discussed, for example, with reference to FIG. 5.

In an example implementation, a mobile IAB node 470 may advertise, at step 603, its mobility profile in the MOBILITY INFORMATION message 531 when the IAB support advertising is enabled (i.e. when sending the IAB support information in the MOBILITY INFORMATION message 531). For example, when the IAB node 470 can support network connectivity for a wireless communication device (such as an IAB node/UE), the MOBILITY INFORMATION message 531 may include the mobility profile information and the IAB support information. In another example implementation, a mobile IAB node 470 may advertise, at step 603, its mobility profile in the MOBILITY INFORMATION message 531 when IAB support is disabled (i.e. when not sending the IAB support information in the MOBILITY INFORMATION message 531). For example, when the IAB node 470 cannot support network connectivity for a wireless communication device (such as an IAB node/UE), the MOBILITY INFORMATION message 531 sent by the mobile IAB node 470 may still include the mobility profile information even though the IAB support information is set (e.g. not included in the MOBILITY INFORMATION message 531).

Referring now also to FIG. 7 which is a schematic and simplified diagram illustrating some example message flows for use in managing the connection of a wireless communication device (referred to in FIG. 7 as a network device) to a mobile IAB node according to some embodiments of the present invention. The network device or wireless communication device may be an IAB node with the mobile IAB node being a parent mobile IAB node or a UE (such as UE 135 or 136 of FIG. 1 and UE 390 of FIG. 4 as described above) where the mobile IAB node is an access node.

According to an example, a mobile IAB node 701 (which may correspond to IAB node 123 of FIG. 1 and IAB node 470 of FIG. 4 as described above) may share IAB node mobility information with the IAB Donor 702 (which may correspond to IAB donor node 120 of FIG. 1 and IAB donor CU 401 of FIG. 4 as described above) by sending a MOBILITY INDICATION message 521. MOBILITY INDICATION message 521 is an example of the mobility indication message discussed above with reference to FIGS. 5, 11-14.

A new network device 703 may wish to join the topology managed by the IAB Donor 702 (e.g. IAB topology or network 4001 managed by IAB donor 401). According to one example, Network Device 703 is an IAB node, similar to IAB node 121 or 123. According to another example, Network Device 703 is a UE, similar to UE 135 or 136.

In order to join the topology managed by the IAB Donor 702, Network Device 703 may try and connect to the topology via the mobile IAB node 701 (which would then act as the parent IAB node for Network Device 703 in the case where the Network Device 703 is an IAB node) by performing an RRC Connection establishment procedure 731 with the IAB Donor 702 via the mobile IAB node 701, as specified in 3GPP TS 38.331 and 3GPP TS 38.401. During this procedure, Network Device 703 will exchange the RRCSetupRequest, RRCSetup and RRCSetupComplete messages with the DU part of the mobile IAB node 701 over the Uu interface, while the DU part of the mobile IAB node 701 will convey these messages using the F1AP protocol to the CU part of the IAB Donor 702.

The IAB Donor 702 may reject the connection of the Network Device 703 by sending an RRCReject message, instead of an RRCSetup message, as specified in 3GPP TS 38.331.

Once the connection between the IAB node 703 and the network is established, in case the Network Device 703 is an IAB node, the IAB Donor 702 may decide to configure or reject the configuration of the BH link between the IAB node 703 and the mobile IAB node by sending a CONFIGURATION INFORMATION message 732 to the IAB node 703.

According to one example, the CONFIGURATION INFORMATION message 732 is the RRCReconfiguration message, as defined in 3GPP TS 38.331.

The CONFIGURATION INFORMATION message 732 and RRCReject message/RRCSetup message are examples of a configuration message discussed above with reference to FIGS. 11-14.

The CONFIGURATION INFORMATION message 732 (or RRCReject message/RRCSetup message) sent to the Network Device 703 may include at least one of the following information (what information is included depends on whether the Network Device is an IAB node or a UE):
iab-configReject, or IAB configuration Reject information. If present in the CONFIGURATION INFORMATION message 732, this information indicates to the IAB node 703 that the IAB Donor 702 does not allow the IAB node 703 to become a child IAB node of the mobile IAB node 701.
MobileCellConnectionReject, or Mobile Cell connection rejection information. If present in the CONFIGURATION INFORMATION message 732, this information indicates to a UE 703 that a connection request is rejected because the UE tried to connect to the network via a mobile IAB node.
iab-configRejectCause, or IAB configuration Rejection Cause information. If present in the CONFIGURATION INFORMATION message 732, this information indicates to the IAB node 703 the reason why the iab-configReject information is present in the CONFIGURATION INFORMATION message 732, i.e. why the IAB Donor 702 does not allow the IAB node 703 to become a child IAB node of the mobile IAB node 701. In an example, the IAB configuration Rejection Cause information may inform the IAB node 703 that the IAB Donor CU 702 does not allow the IAB node 703 to become a child IAB node of the mobile IAB node 701 because the IAB node 701 is a mobile IAB node.
mobility-Profile, or mobility profile information. This information provides indication on the mobility capabilities of the mobile IAB node 701. The mobility profile information may include at least one of the following information:
   speed-related information or speed information indicating a speed capability of the mobile IAB node, such as minimum speed, average speed, maximum speed.
   information on the mobility area, or mobility range, of the mobile IAB node (e.g. range information indicating a mobility area of the mobile IAB node), such as a type of mobility area, a size of mobility area, or a list gathering the Cell IDs of the several Cells that the mobile IAB node previously visited or may visit. The type (or category) of mobility area can be an indication of the size or nature of the geographical area in which the mobile IAB node may move. For example, the type (or category) of mobility area may indicate the geographical area is a bus route, or a train route, or a car park.
   Information (e.g. static information) indicating the duration of the static period(s) the mobile IAB node may experience, such as a minimum static period duration, average static period duration or maximum static period duration.
Itinerary information, which would be made of a sequence of mobility and static periods (e.g. indicating a sequence of mobility and static periods for an itinerary the mIAB node may follow). The Itinerary information may include for each of mobility and static periods, the duration of the period as well as the speed of the mobile IAB node during this period.
mobileParentiab-NodeIndication, or mobile Parent IAB node indication information. This information is used to indicate that the parent IAB node (i.e. IAB node 701) is a mobile IAB-node (i.e. an IAB-node having mobility capability) and that the associated cell is a mobile cell.

FIG. 8 illustrates, using a flowchart 800, an example method for managing the connection of a wireless communication device (referred to with respect to FIG. 8 as a Network Device) to a network (e.g. IAB network or topology) of a wireless communication system via a mobile IAB node according to some embodiments of the present invention. The flowchart 800 shows steps performed at the wireless communication device (or a network device) and the IAB donor node and are examples of steps performed at the wireless communication device and the IAB donor node as described above with reference to FIGS. 11-14. The network device or wireless communication device may be an IAB node or a UE (such as UE 135 or 136 of FIG. 1 and UE 390 of FIG. 4 as described above) where the mobile IAB node is an access node. The method as shown in and described with respect to FIG. 8 may be performed by software elements and/or hardware elements.

The process starts at step 801 where a new Network Device, similar to Network Device 703 (such as IAB node 460 or UE 390 of FIG. 4), requests to join the topology managed by the IAB Donor 702, such as the CU part or CU of IAB Donor 702 (e.g. topology or network 4001 managed by IAB donor 401 of FIG. 4), via a mobile IAB node 701 (such as mobile IAB node 470 of FIG. 4), which is also referred to as the connecting IAB node 701.

According to one example, the new Network Device 703 is an IAB node, similar to IAB node 121 or 123 or IAB node 460.

According to another example, the new Network Device 703 is a UE, similar to UE 135 or 136 or UE 390.

In order to join the topology or network managed by the CU of the IAB Donor 702, the new Network Device 703 may try and connect to the network via the connecting IAB node 701 (which would then act as the parent IAB node for Network Device 703 in the case where the Network Device 703 is an IAB node) by performing an RRC Connection establishment procedure with the IAB Donor 702, as specified in 3GPP TS 38.331, and by sending a request to the IAB Donor 702.

At step 802, the CU of the IAB Donor 702 (e.g. IAB donor CU 401) performs the connection procedure with the new Network Device 703 and checks the mobility capability and status information associated with the connecting IAB-node 701 so as to determine whether to allow or not the connection of the Network Device 703 to the network via the connecting IAB node 701. In the case where the Network Device 703 is an IAB node, the CU part of the IAB Donor 702 determines whether to allow or not the configuration of the BH link between the new Network Device 703 and the connecting IAB node 701 (which would then act as the parent IAB node for the new Network Device 703).

In an example, the CU of the IAB Donor 702 (e.g. IAB donor CU 401) checks the IAB node mobility information embedded in a MOBILITY INDICATION message 521 previously received from the connecting IAB node 701 to determine whether to allow or reject the connection and in the case of the new Network Device 703 being an IAB node, to determine whether to allow or not the configuration of the BH link between the new Network Device 703 and the connecting IAB node 701 (which would then act as the parent IAB node for the new Network Device 703).

The CU of the IAB Donor 702 may request the sending of a MOBILITY INDICATION message 521 to the connecting IAB node 701 so as to get the most up-to-date IAB node mobility information. In an example, the MOBILITY INDICATION message 521 is a UEInformationResponse message which is sent by the connecting IAB node 701 to the CU of the IAB Donor node 702 in response to a UEInformationRequest message, as defined in 3GPP TS 38.331, sent by the IAB Donor 702 to the connecting IAB node 701.

In an example, the CU of the IAB Donor 702 may not allow the connection of the new Network Device 703 to the topology or network it manages in case the mobile IAB node indication information (mobileiab-NodeIndication) in a previously received MOBILITY INDICATION message 521 from the connecting IAB node indicates that the connecting IAB node 701 is a mobile IAB node.

In another example in the case where the new Network Device 703 is an IAB node, the CU of the IAB Donor 702 may not allow the configuration of the BH link between the new Network Device 703 and the connecting IAB node in a case where the mobile IAB node indication information (mobileiab-NodeIndication) in a previously received MOBILITY INDICATION message 521 from the connecting IAB node indicates that the requested parent IAB node 701 is a mobile IAB node.

In another example, the CU of the IAB Donor 702 may allow the connection of the new Device 703 to the network via the connecting IAB node 701 or, in case the Network Device 703 is an IAB-node, the CU of the IAB Donor 702 may allow the configuration of the BH link between the new IAB node 703 and the connecting IAB node 701 (that would then act as a parent IAB node), even though the connecting IAB node 701 is a mobile IAB node, as long as the mobile IAB node 701 is static or will remain static for a time period greater than a certain threshold (e.g. the threshold may be as low as a few tens of seconds) as determined based on the mobility status indication information and/or the guaranteed static time information in a previously received MOBILITY INDICATION message 521 from the connecting IAB node 701.

According to another example, the CU of the IAB Donor 702 may allow the connection of the new Device 703 to the network via the connecting IAB node 701 or, in case the Network Device 703 is an IAB-node, the CU of the IAB Donor 702 may allow the configuration of the BH link between the new IAB node 703 and the connecting IAB node 701 (that would then act as a parent IAB node) even though the connecting IAB node 701 is a mobile IAB node, as long as the mobility of the mobile IAB node 701 is limited. In other words, as long as the connecting IAB node 701 is moving with limited mobility.

The mobility of a mobile IAB node may be considered as limited if one of the limited mobility criteria/conditions as discussed above (e.g. in the description of FIG. 11 and/or FIGS. 13 and 14), or any combination thereof, is met.

At step 803, in an example where the CU of the IAB Donor 702 decides not to allow the configuration of the BH link between a new IAB node 703 and the connecting IAB node 701, the CU of the IAB Donor 702 sends a CONFIGURATION INFORMATION message 732 to the new IAB node 703 that includes all or part of the following information, as defined above with reference to FIG. 7:
iab-configReject, or IAB configuration Reject information for indicating the connection or configuration has been rejected;
iab-configRejectCause, or IAB configuration Rejection Cause information for indicating why the connection has been rejected (e.g. because the connecting IAB node 701 is a mobile IAB node);
mobility-Profile, or mobility profile information for indicating the mobility capability of the connecting IAB node 701.

At step 803, in an example where the CU of the IAB Donor 702 decides to allow the configuration of the BH link between the new IAB node and the requested parent IAB node, the CU of the IAB Donor 702 sends a CONFIGURATION INFORMATION message 732 to the new IAB node 703 that does not include the following information, as defined in FIG. 7:
iab-configReject, or IAB configuration Reject information;
iab-configRejectCause, or IAB configuration Rejection Cause information;

Still, in this latter case, the CONFIGURATION INFORMATION message 732 sent to the new IAB node 703 may include the following information, as defined above with reference to FIG. 7:
mobility-Profile, or mobility profile information for indicating the mobility capability of the connecting IAB node 701.

At step 803, in an example where the CU of the IAB Donor 702 decides not to allow the connection of the new Network Device 703 to the network, the CU of the IAB Donor 702 may send an RRCReject message to the Network Device 703 and add to this message all or part of the following information:
RRCRejectCause, or RRC Rejection Cause information. If present in the RRCReject message, this information indicates to the Network Device 703 the reason why the connection of the Network Device 703 to the network was rejected. According to an example, the RRC Rejection Cause indicates that the Network Device 703 tried to connect to the network via a mobile node, such as a mobile IAB node or a mobile IAB Donor DU. MobileCellConnectionReject, or Mobile Cell connection rejection information is an example of RRCRejectCause, or RRC Rejection Cause information that may be included in the RRCReject message sent to a UE 703 when a connection request is rejected because the UE tried to connect to the network via a mobile IAB node.
mobility-Profile, or mobility profile information for indicating the mobility capability of the connecting IAB node 701, as defined above with reference to FIG. 7.

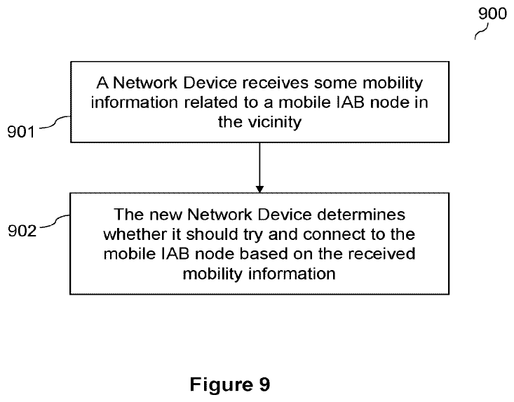

FIG. 9 illustrates, using a flowchart 900, an example method for a wireless communication device (referred to with respect to FIG. 9 as a Network Device) to manage its connection to a network (e.g. IAB network or topology) of a wireless communication system via a mobile IAB node, based on the mobility capability and status of the mobile IAB node, according to some embodiments of the present invention. The method as shown in and described with respect to FIG. 9 may be performed by software elements and/or hardware elements.

The process starts at step 901 where a new Network Device, similar to Network Device 703 (such as IAB node 460 or UE 390 of FIG. 4), receives some mobility information from mobile IAB node in the vicinity, such as mobile IAB node 701 (e.g. mobile IAB node 470 of FIG. 4), which is also referred to as the connecting IAB node 701.

According to one example, the new Network Device 703 is an IAB node, similar to IAB node 121 or 123 or IAB node 460.

According to another example, the new Network Device 703 is a UE, similar to UE 135 or 136 or UE 390.

In an example implementation, the mobility information relates to all or part of the IAB node mobility information carried in a MOBILITY INFORMATION message 531, as described with reference to FIG. 5. MOBILITY INFORMATION message 531 is an example of the mobility information message discussed above with reference to FIGS. 11-14. At step 902, based on the mobility information received at step 901, the new Network Device 703 determines whether it should try and connect to the network via the mobile IAB 701 node by initiating the RRC Connection establishment procedure 731, as described above with reference to FIG. 7.

According to one example, the new Network Device 703 may not try to connect to the network via the connecting IAB node 701 in case the mobile IAB node indication information (mobileiab-NodeIndication) in the MOBILITY INFORMATION message 531 indicates that IAB node 701 is a mobile IAB node.

According to another example, the new Network Device 703 may try and connect to the network via the connecting IAB node 701, even though the connecting IAB node 701 is a mobile IAB node, as long as the mobile IAB node 701 is static or will remain static for a time period greater than a certain threshold (e.g. the threshold may be as low as a few tens of seconds) as determined based on the mobility status indication information and/or the guaranteed static time information in a previously received MOBILITY INFORMATION message 531 from the connecting IAB node 701.

According to another example, the new Network Device 703 may try and connect to the network via the connecting IAB node 701 even though the connecting IAB node 701 is a mobile IAB node, as long as the mobility of the mobile IAB node 701 is limited. In other words, as long as the connecting IAB node 701 is moving with limited mobility. The mobility of a mobile IAB node 701 may be considered as limited if one of the limited mobility criteria/conditions as discussed above (e.g. in the description of FIG. 11 and/or FIGS. 13 and 14), or any combination thereof, is met.

It is provided hereafter, for clarity purpose, an illustration of some aspects of the present invention.

During recent discussions in 3 GPP (RAN3 #117 e meeting), it was agreed that the IAB-donor-CU should be aware of the “mobile” capability of an IAB node. Meanwhile, RAN2 initiated some discussion about whether the mobile IAB-MT needs to send a mobile-IAB indication (capability or mobility) to the IAB-donor-CU.

Therefore, some specific mobility signalling towards the IAB-donor-CU may be considered at mobile IAB node level to allow efficient network connectivity management at IAB-donor-CU.

It was proposed in 3GPP that the mobile IAB-node reports mobility-related information to the network, e.g., so that the CU may include such information in UE handover decisions, simplify some RRC procedures, allow the network to create a mobile IAB mobility history, reject the connection request of an IAB-node with the mobile IAB-node as a parent node . . .

Having the knowledge of the mobile nature of an IAB node may also allow the IAB-donor-CU to decide for full migration instead of partial migration in the context of topology adaptation.

The mobility-related information to be shared with the IAB-donor-CU may include:
Speed (min., average or max.);
Mobility range (e.g. mobility area type, or distance);
Trajectory (including a succession of mobile and static periods) Thus, along with informing the IAB-donor-CU about its mobile capability, the mobile IAB node may share some mobility profile with the IAB-donor-CU. Such mobility profile may include information related to the nature of the IAB node mobility, such as speed, mobility range or trajectory.

The RRC setup procedure already allows an IAB-MT to indicate to its IAB-donor-CU that the connection is being established by an IAB-node. In the same way, mobile capability signalling may be performed as part of the mobile IAB node RRC setup procedure, which would then be performed by the IAB-MT. In other words, the IAB Node Indication is already sent by the IAB-MT to the IAB-donor-CU using RRC (iab-NodeIndication information in RRCSetupComplete message).

Therefore, the IAB-MT should send a mobile IAB Node indication, along with the existing iab-NodeIndication and some mobility capability information, to the IAB-donor-CU using RRC.

As some of the mobility parameters (e.g. speed) of an IAB-node are likely to evolve, it may be beneficial for the IAB-donor-CU to be informed on such evolution. Therefore, some mobile capability signalling may be issued by the mobile IAB-node upon detection of a change in the IAB node mobility status or on a periodic basis.

Thus, mobile capability signalling may be performed as part of the mobile IAB node setup procedure. Still, some mobility signalling may also be performed on a periodic basis or upon detection of a change in the IAB node mobility status.

As the Release 18 introduces the concept of mobile IAB cell, it may be beneficial for a UE to have some knowledge on the fixed or mobile nature of its surrounding cells in case it wants to connect to one of them. This would not apply to legacy UEs (i.e. UEs not supporting Rel. 18 specifications). For instance, a UE may have some preference for connecting to a fixed cell rather than a mobile cell when connecting to a new cell. The knowledge of the nature of a mobile IAB cell may allow alleviating the need for cell reselection or measurement report for handover. In other words, a UE may benefit from the knowledge about the mobile nature of the IAB nodes in its vicinity (so that the UE may decide whether it should connect to a mobile cell or try and find some other fixed cell).

Therefore, a mobile IAB-node may broadcast some mobile capability signalling towards the UEs in its vicinity using SIB signalling. This Mobile capability signalling may include a mobility profile similar to the one shared with the IAB-donor-CU, hence including some information such as speed, mobility range or trajectory.

As some UEs may prefer connecting to a fixed cell rather a mobile one (e.g. to avoid the need for some handover in case the UE is static while the mobile IAB node is moving away), a mobile IAB node which is currently not moving (e.g. a parked taxi, a bus or a subway train waiting at a station) may advertise its static status, along with the duration for which it will remain static, to the UEs in the vicinity.

Therefore, a mobile IAB-node may broadcast some mobile capability signalling towards the UEs in its vicinity using SIB signalling. This Mobile capability signalling may include a mobility profile similar to the one shared with the IAB-donor-CU.

Also, in case the mobile IAB node is static, the mobile IAB node may inform the UEs in its vicinity about its static status, as well as the duration for which it will remain static.

Considering the scope of Release 18 mobile IAB framework, the mobile IAB-node should have no descendent IAB-nodes, i.e., it serves only UEs. In this respect, it was agreed in 3GPP that the method of not broadcasting “iab-Support” indication is sufficient to prevent other IAB-node from accessing mobile IAB (without further spec impact).

However, a mobile IAB node may become static at some point and remain static for some time period, which duration may even be predictable. For instance, a bus may stop at the bus station for a 30 s-1 mn duration, a train may remain idle at the railway station for up to 5 mn at an intermediate station or even for 30 mn-1 hr and longer at its terminal station.

A mobile IAB node may also have its movement limited to a very restricted geographical area, like for instance a promotional vehicle that is circling around a stadium at the Olympics.

To summarize, a mobile IAB node may become static at some point and remain static for some time period, which duration may be predictable. A mobile IAB node may also have its movement limited to a very restricted geographical area.

In both cases, the impact of the mobile nature of the IAB node on its potential connectivity with other surrounding IAB nodes would be either null or very limited.

Therefore, a mobile IAB node that becomes static, or which has a very limited range of movement, could be considered as a fixed IAB node, and thus have temporary descendent IAB-nodes, as long as it remains static or within a limited geographical area.

Therefore, a mobile IAB node that becomes static can be considered as a fixed IAB node, and thus may have temporary descendent IAB-nodes, as long as it remains static.

Similarly, a mobile IAB node which movement is limited to a small geographical area can be considered as a fixed IAB node, and thus may have temporary descendent IAB-nodes, as long as it remains static.

FIG. 10 shows a schematic representation of an example communication device (apparatus) or station, in accordance with one or more example embodiments of the present disclosure.

The communication device 1000 may be a device such as a micro-computer, a workstation or a light portable device. The communication device 1000 may comprise a communication bus 1013 to which there are connected:
a central processing unit 1011, such as a microprocessor, denoted CPU. The central processing unit 1111 may be a single processing unit or processor or may comprise two or more processing units or processors carrying out the processing required for the operation of the communication device 1100. The number of processors and the allocation of processing functions to the central processing unit 1111 is a matter of design choice for a skilled person;
memory for storing data and computer programs containing instructions for the operation of the communication device 1000. The computer programs may contain a number of different program elements (modules) or sub-routines containing instructions for a variety of operations and for implementing the methods in accordance with one or more embodiments of the invention; and
at least one communication interface 1002 for communicating with other devices or nodes in a wireless communication system, such as the wireless communication system of FIG. 1 or FIG. 4. The at least one communication interface 1002 may be connected to the radio communication network 1003, such as a wireless communication network for 5G NR (e.g. according to the release 16 and/or subsequent releases), over which digital data packets or frames or control frames are transmitted. The frames are written from a FIFO sending memory in RAM 1012 to the communication interface for transmission or are read from the communication interface for reception and writing into a FIFO receiving memory in RAM 1012 under the control of a software application running in the CPU 1011. Each of a donor CU, a donor DU, an IAB node and a UE may comprise such a communication device 1100.

The memory may include:
a read only memory 1007, denoted ROM, for storing computer programs for implementing the methods in accordance with one or more embodiments of the invention;
a random-access memory 1012, denoted RAM, for storing the executable code of methods according to one or more embodiments of the invention as well as the registers adapted to record variables and parameters necessary for implementing methods according to one or more embodiments of the invention.

Optionally (and according to function of the communication device), the communication device 1000 may also include the following components:
a data storage means 1004 such as a hard disk, for storing computer programs for implementing methods according to one or more embodiments of the invention;
a disk drive 1005 for a disk 1006, the disk drive being adapted to read data from the disk 1006 or to write data onto said disk;

a screen 1009 for displaying decoded data and/or serving as a graphical interface with the user, by means of a keyboard 1010 or any other input/output means.

In an example arrangement, the communication bus provides communication and interoperability between the various elements included in the communication device 1000 or connected to it. The representation of the bus is not limiting and in particular, the central processing unit is operable to communicate instructions to any element of the communication device 1000 directly or by means of another element of the communication device 1000.

The disk 1006 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables a method according to embodiments of the invention to be implemented.

The executable code may optionally be stored either in read only memory 1007, on the hard disk 1004 or on a removable digital medium such as for example a disk 1006 as described previously. According to an optional variant, the executable code of the programs can be received by means of the communication network 1003, via the interface 1002, in order to be stored in one of the storage means of the communication device 1000, such as the hard disk 1004, before being executed.

The central processing unit 1011 may be adapted to control and direct the execution of the instructions or portions of software code of the program or programs according to embodiments of the invention, which instructions are stored in one of the aforementioned storage means. On powering up, the program or programs that are stored in a non-volatile memory, for example on the hard disk 1004 or in the read only memory 1007, are transferred into the random-access memory 1012, which then contains the executable code of the program or programs, as well as registers for storing the variables and parameters necessary for implementing the invention.

In an example implementation, the communication device (apparatus) is a programmable device/apparatus which uses software to implement the invention. Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for use in managing network connectivity in a wireless communication system including at least one Integrated Access and Backhaul, (IAB), node, the method at an mIAB node comprising:
providing, to another IAB node or a UE of the wireless communication system, message for indicating whether a cell associated with the IAB node is a mobile cell and whether the cell associated with the IAB node can be considered as a candidate for cell (re)selection,
wherein the message includes:
mobile IAB cell indication information for indicating whether a cell associated with the IAB node is a mobile cell.

2. (canceled)

3. The method of claim 1, wherein the message further includes:
mobility status indication information indicating a current status of mobility of the mIAB node.

4-6. (canceled)

7. The method of claim 1, wherein providing comprises at least one of:
providing the message after completion of an IAB node setup procedure;
providing the message in response to the mIAB node determining a change in mobility;
providing the message periodically.

8. The method of claim 7, wherein providing comprises broadcasting the message.

9-10. (canceled)

11. The method of claim 1, wherein when the cell associated with the mIAB node is barred for the other IAB node, not including IAB support information in the message to indicate the cell associated with the IAB node is barred for the other IAB node.

12. The method of claim 1, further comprising receiving from an IAB donor node controlling the IAB node, a connectivity support configuration message, the connectivity support configuration message indicating whether a cell associated with the IAB node can be considered as a candidate for cell (re)selection, wherein the IAB node determines whether the cell associated with the IAB node can be considered as a candidate for cell (re)selection based on the received connectivity support configuration message.

13. The method of claim 1, further comprising determining by the mIAB node whether a cell associated with the IAB node can be considered as a candidate for cell (re)selection based on mobility of the mIAB node.

14. The method of claim 13, further comprising:
determining a cell associated with the IAB node can be considered as a candidate for cell (re)selection when the mIAB node is static for a time period greater than a certain threshold or when the mIAB node is moving with limited mobility.

15. The method of claim 14, the mobility of the mIAB node is limited when at least one of the following criteria is met:
the speed of the mIAB node is below a certain threshold,
the mobility area is geographically limited,
the mobility area is within one topology or one network cell.

16-18. (canceled)

19. A method at a wireless communication device of a wireless communication system, the wireless communication device being a first Integrated Access and Backhaul, IAB, node or a UE, the wireless communication system further comprising a second IAB node, the method at the wireless communication device comprising:
receiving, from the second IAB node, a message;
performing an action based at least in part on information provided by the received message,
wherein the message indicates whether a cell associated with the second IAB node is a mobile cell and whether a cell associated with the second IAB node can be considered as a candidate for cell (re)selection.

20. (canceled)

21. The method of claim 19, wherein the message further includes mobility status indication information indicating a current status of mobility of the second IAB node;

22. (canceled)

23. The method of claim 19, wherein performing an action comprises:
determining whether to initiate a connection establishment procedure for establishing a connection via the second IAB node based on the message.

24. The method of claim 23, wherein determining comprises determining not to initiate a connection establishment procedure when the message indicates the cell associated with the second IAB node is barred for the wireless communication device.

25. The method of claim 23, wherein determining comprises determining to initiate a connection establishment procedure when information provided by the message indicates certain criteria are met, the certain criteria including one of: the second IAB node is not a mobile IAB node; the second IAB node is a mobile IAB node and is static for a time period greater than a certain threshold; the second IAB node is a mobile IAB node and is moving with limited mobility.

26. The method of claim 25, wherein the mobility of the second IAB node is limited when at least one of the following criteria is met:
the speed of the second IAB node is below a certain threshold,
the mobility area is geographically limited,
the mobility area is within one topology or one network cell.

27-61. (canceled)

62. An apparatus for an Integrated Access and Backhaul, IAB, node of a wireless communication system, the apparatus comprising:
one or more central processing units configured to:
provide, to another IAB node or a UE of the wireless communication system, a message for indicating whether a cell associated with the IAB node is a mobile cell and whether the cell associated with the IAB node can be considered as a candidate for cell (re)selection, wherein the message includes:
mobile IAB cell indication information for indicating whether a cell associated with the IAB node is a mobile cell.

63. (canceled)

64. An apparatus for a wireless communication device, wherein the wireless communication device is a first Integrated Access and Backhaul, IAB, node or a UE, the apparatus comprising:
one or more processing units configured to;
receive, from a second IAB node, a message;
perform an action based at least in part on information provided by the received message,
wherein the message indicates whether a cell associated with the second IAB node is a mobile cell and whether a cell associated with the second IAB node can be considered as a candidate for cell (re)selection.

65. (canceled)

66. A non-transitory computer-readable storage medium carrying a computer program comprising instructions which, when the program is executed by a computer of an Integrated Access and Backhaul, IAB, node of a wireless communication system, cause the IAB node to:
provide, to another IAB node or a UE of the wireless communication system, a message for indicating whether a cell associated with the IAB node is a mobile cell and whether the cell associated with the IAB node can be considered as a candidate for cell (re)selection,
wherein the message includes:
mobile IAB cell indication information for indicating whether a cell associated with the IAB node is a mobile cell.

67. The method of claim 19, wherein performing an action includes determining the cell associated with the second IAB node is barred for the wireless communication device based on the mobility information message.

68. The method of claim 19, wherein when the cell associated with the second IAB node is barred for the wireless communication device, IAB support information is not included in the message to indicate the cell associated with the second IAB node is barred for the wireless communication device.

69. The apparatus of claim 62, wherein the message further includes:
mobility status indication information indicating a current status of mobility of the IAB node.

70. The apparatus of claim 62, wherein the one or more processing units are configured to provide the message by at least one of:
providing the message after completion of an IAB node setup procedure;
providing the message in response to the IAB node determining a change in mobility;
providing the message periodically.

71. The apparatus of claim 62, wherein when the cell associated with the IAB node is barred for the other IAB node, IAB support information is not included in the message to indicate the cell associated with the IAB node is barred for the other IAB node.

72. The apparatus of claim 62, wherein in the case where the wireless communication device is an IAB node and the IAB node receives, from an IAB donor node controlling the IAB node, a connectivity support configuration message, the connectivity support configuration message indicating whether a cell associated with the IAB node can be considered as a candidate for cell (re)selection, the one or more processing units of the IAB node are configured to determine whether the cell associated with the IAB node can be considered as a candidate for cell (re)selection based on the received connectivity support configuration message.

73. The apparatus of claim 62, wherein in the case where the wireless communication device is an IAB node, the one or more processing units of the IAB node are further configured to determine whether a cell associated with the IAB node can be considered as a candidate for cell (re)selection based on mobility of the IAB node.

74. The apparatus of claim 64, wherein the message further includes:
mobility status indication information indicating a current status of mobility of the second IAB node.

75. The apparatus of claim 64, wherein the one or more processing units are configured to determine whether to initiate a connection establishment procedure for establishing a connection via the second IAB node based on the message.

76. The apparatus of claim 75, wherein the one or more processing units are configured to determine not to initiate a connection establishment procedure when the message indicates the cell associated with the second IAB node is barred for the wireless communication device.

77. A non-transitory computer-readable storage medium carrying a computer program comprising instructions which, when the program is executed by a computer of a wireless communication device, wherein the wireless communication device is a first Integrated Access and Backhaul, IAB, node or a UE, cause the wireless communication device to:
receive, from a second IAB node, a message;
perform an action based at least in part on information provided by the received message,
wherein the message indicates whether a cell associated with the second IAB node is a mobile cell and whether a cell associated with the second IAB node can be considered as a candidate for cell (re)selection.
